(19) United States
(12) Patent Application Publication
(10) Pub. No.: US 2002/0085287 A1
(43) Pub. Date: Jul. 4, 2002

(54) Microlens array and display comprising microlens array

(75) Inventor: Yutaka Egawa, Tokyo (JP)

Correspondence Address: Patrick G. Burns, Esq., GREER, BURNS & CRAIN, LTD., Suite 2500, 300 South Wacker Dr., Chicago, IL, 60606, US

(73) Assignee: Comoc Corporation

(21) Appl. No.: 10/059,602

(22) Filed: Jan. 29, 2002

Related U.S. Application Data
(63) Continuation of application No. PCT/JP00/05084, filed on Aug. 1, 2000.

(30) Foreign Application Priority Data
Aug. 2, 1999 (JP) 11-218313
Nov. 10, 1999 (JP) 11-319176
Feb. 29, 2000 (JP) 2000-53954
May 26, 2000 (JP) 2000-156608
May 31, 2000 (JP) 2000-162231
Jul. 26, 2000 (JP) 2000-225557

(51) Int. Cl. G02B 27/10

(52) U.S. Cl. 359/619; 359/621; 359/622; 359/623

(57) ABSTRACT

A display comprising a microlens array which includes microlenses sufficiently smaller than the length of one side of an effective region and in which the optical axes of two adjacent microlenses are independent of each other, and a two-dimensional display image or an image support for supporting such a two-dimensional display image so that the two-dimensional display image is opposed to the microlenses and disposed at a point close to the focal points of the microlenses and at a point not close to the curved surfaces of the microlenses in a position between the focal points of the microlenses and the curved surfaces of the microlenses and not very close to the focal points and the curved surfaces of the microlenses, wherein the observer facing the microlenses can view the two-dimensional display image through the microlenses. The two-dimensional display image can be viewed like a three-dimensional image only by varying the position of the image without varying the size of the image equivalently.

### CROSS REFERENCE TO RELATED APPLICATION

This application is a continuation of International PCT Application No. PCT/JP00/05084 filed on Aug. 1, 2000.

### BACKGROUND OF THE INVENTION

1. Field of the Invention

The present invention relates to a display device such as an indoor or outdoor information board, guide board, display tower, etc., a television receiver, an electronic display such as a monitor of a personal computer, a video system for movies, etc., and more specifically to a display device for displaying a two-dimensional image as if it were a three-dimensional image. In addition, the present invention also relates to a microlens array comprising an array of a large number of lenses used for the display device.

2. Description of the Related Art

Some methods have been already known as methods of viewing a two-dimensional image of a photo, a printed image, etc. as a three-dimensional image. The ‘Three-dimensional Image Technology’ by Takanobu Ohkoshi summarizes and presents these methods. A typical example is to view a photo (or a drawn image) obtained by capturing a target object from different two directions respectively with a left eye and a right eye. That is, the three-dimensional view can be obtained by the binocular parallax. In this method, it is necessary for the left and right eyes to look into the devices designed to show different images for the respective eyes. Therefore, it is not appropriate for common information boards and guide boards.

Another example is a three-dimensional image using a lenticular plate. It is a method of recognizing a two-dimensional image as if it were a three-dimensional image by dividing a plurality of two-dimensional images viewed from different directions into narrow strips, and arranging them as a horizontal array of strips showing a discontinuous pattern of a display image on the reverse side of the focal point surface of the lenticular plate having a number of long semicylindrical lenses arranged in the horizontal direction.

In this method, it is necessary to arrange display images viewed from a plurality of positions in 1-array pitch of a semicylindrical lens forming part of the lenticular plate, thereby requiring exceedingly high precision in the position of a display image. Therefore, to satisfy the strict conditions, images are printed on the reverse side of the focal point surface of the lenticular plate.

The conventionally known three-dimensional image display technology using a lenticular plate is hereinafter referred to as an LS display technology.

The display image used in the LS display technology is obtained by continuously arranging a number of strips of images forming a special image in the form of stripes of discontinuous images. Furthermore, the position of the display image is strictly set very close to the focal point surface.

A large information and guide board in the conventional three-dimensional display system using the lenticular plate requires a specially generated image, and strict conditions for alignment between an image and a lens. Therefore, it is costly and has difficulty in replacement.

Furthermore, the ‘Three-dimensional Image Technology’ by Takanobu Ohkoshi includes an instructive abstract as follows about a three-dimensional image.

‘When a photo is viewed through a magnifying glass with one eye, the image viewed with one eye at an appropriate position looks unexpectedly three-dimensional’.

The reason is summarized as follows in the document.

‘Since the image is viewed with one eye, the binocular parallax and the superposition do not work. However, the adjusting function of the eyes is effective. As a result of the position of the virtual image moved from the position of the real image, the clue to the determination whether it is a two- or three-dimensional image is lose, thereby determining by the brain that it is a three-dimensional image by experience’.

That is, according to the explanation in the document, when an image is moved from the position of the real image, the brain has a false impression that the image is a three-dimensional image.

Unlike in the LS display technology, the display image viewed through a magnifying glass is a two-dimensional image of a photo, etc. normally viewed as the entire continuous image such as the image of a photo, a picture, etc.

However, with the progress of plastic processing technology, a large convex lens in the Fresnel system has been more easily obtained. Nevertheless, it has not been put for practical use as an information or guide board. Although the reason has not been completely clear, it is assumed to be partly because the image is enlarged, and therefore the entire image behind the lens cannot be simultaneously viewed, that is, only a part of the image can be viewed. The demerit of viewing only a part of the image is a serious problem as a display device that the display scope depends on the direction of a viewer.

The present invention has been developed to solve the above mentioned problem, and aims at providing a display device capable of displaying a two-dimensional image formed by a continuous image such as a photo taken in a normal method, or a picture drawn in a normal method after converting it into an image which looks three-dimensional and brighter. The effective technology resides in utilizing the phenomenon that, as described above, the image viewed through a lens appears to the brain three-dimensional by a false impression when the image is shifted from the position of the real image.

The first object of the present invention is to provide a display device capable of displaying a two-dimensional image as if it were a three-dimensional image after changing only the position of the image without equivalently changing the size of the image.

The second object of the present invention is to provide a video system which has a screen and a projection mechanism, and can display movies, slide films, projection TV, etc. as three-dimensional images.

The third object of the present invention is to provide a microlens array, which has a number of microlenses having long focal lengths, to be applied to the display device and the video system provided according to the first and second objects of the present invention.

### SUMMARY OF THE INVENTION

To solve the above mentioned problems, the present invention has the following configuration.

The invention according to the 1st aspect has a display device including: a microlens array which includes microlenses sufficiently smaller than the length of the side of an effective region and in which the optical axes or optical axis surfaces of the two adjacent microlenses are independent of each other; and at least one of a two-dimensional display image or an image support for supporting the two-dimensional display image such that the two-dimensional display image can be opposed to the microlens array and disposed at a point close to the focal points of the microlenses and at a point not close to the curved surfaces of the microlenses in a position between the focal points of the microlenses and the curved surfaces of the microlenses, wherein the observer facing the microlens array can view the two-dimensional display image through the microlenses.

According to the 1st aspect of the present invention, an image formed by each of the microlenses forming the microlens array is defined a new pixel, and a group of pixels is viewed as an entire image of the display image attached to the image support. Therefore, the entire image of the display image is not enlarged or reduced. Only the position of the image is shifted forward or backward from the position of the display image according to the rule of microlenses.

Furthermore, since the display image is opposed to the microlens array and disposed at a point close to the focal points of the microlenses and at a point not close to the curved surfaces of the microlenses in a position between the focal points of the microlenses and the curved surfaces of the microlenses, the image formed by the microlenses is an erect image of an appropriate size having no large or small magnification or reduction, thereby excelling in continuity of pixels as an image. Furthermore, since the optical axes of two close microlenses are independent of each other, a plurality of images of the microlenses can be prevented from being collected into one large image, thereby guaranteeing the size of the pixel equal to the size of the microlens.

The image support can define the relative position between a display image and the curved surface of the lens of the microlens array, and can maintain the relative position although the display image is replaced.

The display device according to the 2nd aspect is based on the 1st aspect in which the boundary surface forming the microlens array is evenly and smoothly curved with a radius sufficiently larger than the thickness of the microlens array including the virtual lens surface of the microlens array, and/or the microlens array is inclined to the observer such that the rate of the area in the microlens in which the angle made between the eyes of the observer and the normal of the curved surface is larger can increase.

According to the 2nd aspect of the present invention, the image of the microlens is an erect image based on the condition of the position of the display image. In addition, since the optical axis of the curved surface of the vicinal microlens is independent, the size of the entire image can be limited.

If the microlens array is inclined to the observer, the portions at which the incident angle of the eyes of the observer is larger increases, thereby increasing the portion of a larger incident angle of the eyes to the curved surface of the lens. As a result, only by changing the angle of the inclination of the microlens array toward the observer, the focal length of the microlens can be changed.

When the microlens array is curved, the focal lengths of the microlenses of the microlens array can be changed depending on the positions in the microlens array. Therefore, each part of the entire image can be formed at a different position along the optical axis depending on the focal length. However, the entire image is not enlarged or reduced in any direction. Furthermore, the distortion of the entire image by the curved surface of the microlens array is be small enough to be ignored.

The display device according to the 3rd aspect of the present invention is based on the 1st aspect. In the display device, the gap between the curved surface of the lens and the display image is filled with transparent solid, liquid, or clear solid and liquid.

According to the 3rd aspect of the present invention, there is no boundary surface having a small refractive index touching air between the curved surface and the display image, thereby reducing the large reflection on the boundary surface, and easily showing a clear display image. In addition, external illumination is not reflected by the boundary surface because the boundary surface touching air can be removed.

A microlens array according to the 4th aspect of the present invention includes one or more boundary surfaces on which the transparent portions touch each other by layering two or more transparent portions having different refractive indices sufficiently larger than the refractive index of air, wherein at least one of the boundary surfaces forms a lens curved surface including a group of microcurve surfaces arranged at an array pitch sufficiently smaller than the length of one side of the effective region, each of the boundary surfaces, which are the lens curved surfaces, has the following inequality (1), in which r indicates the curvature radius r of the microcurve surface of the boundary surface which is the lens curved surface, nₚ indicates the absolute refractive index nₚ of one material touching the microcurve surface, nₛ indicates the absolute refractive index nₛ of the other material touching the microcurve surface, R indicates the curvature radius of the other boundary surface, Nₚ indicates the absolute refractive index Nₚ of one of the materials touching other boundary surfaces, and Nₛ indicates the absolute refractive index Nₛ of the other material touching other boundary surfaces, to the lens curved surface touching the boundary surface which is the lens curved surface and the other boundary surfaces containing the boundary surface to an external region not touching the lens curved surface.

|R(Nₚ−Nₛ)″>>|r/(nₚ−nₛ)| (1)

According to the 4th aspect of the present invention, since the inequality (1) is effective, the boundary surface has the highest function as a lens, and can be one or more boundary surfaces including microcurve surfaces on which two or more transparent portions touch each other, thereby increasing the flexibility in designing a lens. Furthermore, the focal length can be controlled by appropriately selecting the refractive indices of the transparent portions having the lens curved surface as a boundary surface. Especially, as compared with the case in which air functions as a boundary surface, a larger absolute value of the focal length of a lens can be easily obtained, and an excellent microlens array for displaying a two-dimensional display image as if it were a three-dimensional image can be easily obtained.

The microlens array according to the 5th aspect of the present invention is based on the microlens array according to the 4th aspect, wherein at least one of the transparent portions is a transparent liquid, and other transparent portions are transparent solids.

According to the 5th aspect, one of the boundary surfaces forming the lens curved surface is a solid capable of fixing the form of the lens curved surface, and the other is a transparent liquid which can be flexibly transformed following the form of the solid, thereby easily realizing a closely contacting boundary surface.

The microlens array according to the 6th aspect is based on the microlens array according to the 4th aspect, wherein at least one of the transparent portions is a transparent glue or a transparent adhesive, and other transparent portions can be transparent solids.

According to the 6th aspect of the present invention, the transparent glue and adhesive are flexible, and can be applied to or can be added with pressure to a portion forming a curved surface to easily form a closely touching boundary surface, and can be used as a glue and an adhesive to fix the lens curved surface to form a microlens array.

The microlens array according to the 7th aspect of the present invention is based on the microlens array according to the 4th aspect, wherein the lens curved surface is opposed to the outside of the window glass, and the gap between the surface of the outside of the window glass and the lens curved surface is filled with a transparent solid or a transparent liquid.

According to the 7th aspect of the present invention, there is no boundary surface of air having a large reflectivity between the outside of the window glass and the lens curved surface. Furthermore, the microlens array can be incorporated into the window glass.

The microlens array according to the 8th aspect of the present invention includes one or more boundary surfaces on which the transparent portions touch each other by layering two or more transparent portions having different refractive indices sufficiently larger than the refractive index of air, wherein at least one of the boundary surfaces forms a lens curved surface including a group of microcurve surfaces which are arranged at an array pitch sufficiently smaller than the length of one side of the effective region, and two of which are close to each other and have different optical axes or axis surfaces, each of the boundary surfaces, which are the lens curved surfaces, has the following inequality (2), in which r indicates the curvature radius r of the microcurve surface of the boundary surface which is the lens curved surface, nₚ indicates the absolute refractive index nₚ of one material touching the microcurve surface, nₛ indicates the absolute refractive index nₛ of the other material touching the microcurve surface, R indicates the curvature radius of the other boundary surface, Nₚ indicates the absolute refractive index Nₚ of one of the materials touching other boundary surfaces, and Nₛ indicates the absolute refractive index Ns of the other material touching other boundary surfaces, to the lens curved surface touching the boundary surface which is the lens curved surface and the other boundary surfaces containing the boundary surface to an external region not touching the lens curved surface.

|R/(Nₚ−Nₛ)|>>|r/(nₚ−nₛ)| (2)

According to the 8th aspect of the present invention, since the inequality (2) is effective, the boundary surface has the highest function as a lens, and can be one or more boundary surfaces including microcurve surfaces on which two or more transparent portions touch each other, thereby determining the performance of the lenses on this boundary surface. Furthermore, the focal length can be controlled by appropriately selecting the refractive indices of the transparent portions having the lens curved surface as a boundary surface. Especially by setting the curvature radius R of the boundary surface to the external field, that is, air, to have a sufficiently large surface close to a plane, a lens having a long focal length with a microcurve surface having a small curvature radius r.

Furthermore, since the optical axes of two close microlenses are independent of each other, a plurality of images of the microlenses can be prevented from being collected into one large image, thereby preventing the dimension of a microlens from being recognized to be partially enlarged.

The microlens array according to the 9th aspect is based on the 8th aspect, wherein the focal point of the microlens formed by a synthetic optical systems having a number of stages of boundary microcurve surfaces forming the lens curved surface is externally disposed apart from the microlens array forming unit, that is, apart more than 5 times the shortest array pitch from the closest microcurve surface.

According to the 9th aspect of the present invention based on the effect of the 8th aspect, wherein the focal length can be maintained equal to or larger than a predetermined value, and the focal point is externally disposed apart from the microlens array forming unit, thereby setting a display image not very close to the focal point, but at the position closer to the lens curved surface than the focal point.

The display device according to the 10th aspect of the present invention includes: a microlens array; and at least one of a two-dimensional image which shows a continuous pattern, is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface, and an image support for supporting a two-dimensional image which is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface.

According to the 10th aspect, a microlens array having a sufficiently long focal length can be used although microlenses are considerably small for high precision. Therefore, a display image can be disposed at the position closer to the lens curved surface than the focal point at the point not very close to the focal point and the lens curved surface. Therefore, the image of the microlens which is also the microcurve surface of the microlens array is an erect image of a significant size with magnification and reduction not too large or too small, thereby excelling in continuity of pixels forming an image. Furthermore, by changing the position of the display image in the above mentioned scope, the rate of appearing a three-dimensional image can be adjusted. Additionally, since the optical axes of vicinal microcurve surfaces are independent of each other, the pixels of the entire image are not enlarged and limited.

The microlens array according to the 11th aspect includes a first type of lens curved surface having a group of microcurve surfaces arranged at a sufficiently short pitch than the length of one side of the effective region, and a second type of lens curved surface having a lens curved surface with a sufficiently larger curvature radius than the curvature radius of the microcurve lens surface, wherein the first type of the lens curved surface is a boundary surface on which a liquid and a solid having different refractive indices or a solid and a solid transparent portion touch each other, and is opposed to the second type of lens curved surface.

According to the 11th aspect, the microlens array has curved surfaces of at least two types (large and small) of curvature radii, and these lens curved surfaces determine the focal length. Therefore, using the difference in production cost of metal mold, etc., a variety of inexpensive metal molds are prepared to product microlens arrays having different focal lengths. In addition, since materials having refractive indices not largely different from each other form contact surfaces, the microlens curved surface having a small curvature radius forming the first type of lens curved surface can be regarded as a lens curved surface having an equivalently large curvature radius, thereby enlarging the focal length beyond the restrictions on its form. As a result, the distance between a display image and the microlens array can be increased, and the light source of the lighting can be easily placed between the microlens array and the display image, thereby improving the lighting efficiency. Furthermore, by satisfying the conditions of the display device and increasing the focal length, a unit capable of appropriately showing an image can be realized.

The display device according to the 12th aspect includes a display element having pixels arranged at a predetermined array pitch, and a microlens array having a group of microlenses arranged at a pitch sufficiently shorter than the length of one side of an effective region, wherein the value obtained by multiplying the array pitch of the microlens by an integer in the direction of the array pitch of the pixels matches the value obtained by multiplying the pixel array pitch by an integer.

According to the 12th aspect, the distance of the pixel array pitch multiplied by an integer corresponds to the distance of the microlens array pitch multiplied by an integer.

The microlens array according to the 13th aspect has a plurality of microlenses having optical axes or optical axis surfaces independent of each other, wherein the microlenses are arranged at a distance sufficiently shorter than the length of one side of an effective region, the optical axes or the optical axis surfaces of the microlenses close to each other are parallel to each other in the vicinity of the lens curved surface, and the focal point positions of the microlenses are outside the microlens forming unit apart at more than five times the array pitch from the lens curved surface.

According to the 13th aspect of the present invention, since the optical axes or the optical axis surfaces of the microlenses are independent of each other, the image of each microlens has pixels independent of the entire image viewed through the microlens array, and the dimensions of the pixels are guaranteed as the dimensions of the microlens. Furthermore, the precision of the display image can be guaranteed, and the display image is not deteriorated by partial irregular dimensions of pixels. The focal length is long enough, is more than 5 times the array pitch of the microlens, and the focal point is outside the microlens array. Therefore, when a display device for displaying a three-dimensional image is designed, the display image can be set apart from the microlens array. Therefore, the lightening can be designed between the display image and the microlens array, the setting conditions of the display image can be reduced, and replacement can be easily performed.

Furthermore, since the optical axes or the optical axis surfaces of the microlenses close to each other are parallel to each other in the vicinity of the lens curved surface, the distance to the point where the optical axes or the optical axis surfaces cross between microlenses when the microlens array is curved for use can be long. Furthermore, since the focal point position is outside the microlens array, a display device configured using the microlenses can set a display image at a position closer to the lens curved surface than the focal point, and can set it apart from the microlens array. Therefore, the adjacent images of the microlenses corresponding to the pixels of the entire image show higher continuity than when a display image is set outside the focal point. As a result, the quality of the display image can be improved.

The microlens array according to the 14th aspect includes a group of a first microlens having the characteristic of a concave lens and a second microlens having the characteristic of a convex lens arranged at an array pitch sufficiently shorter than the length of one side of the effective region, wherein the first microlens and the second microlens having the opposite lens characteristics are connected to each other, and the lens curved surface smoothly continues at the boundary between the first microlens and the second microlens.

According to the 14th aspect of the present invention, when there is the consistency between a reduced image generated by the first microlens having the characteristic of a concave lens and an enlarged image generated by the second microlens having the characteristic of a convex lens, and when the images generated by the adjacent first and second microlenses are synthesized, no missing or overlapping portions exist, and the lens curved surface smoothly changes. Therefore, the entire image generated by the microlens array does not show a sudden change.

The microlens array according to the 15th aspect of the present invention is based on the 14th aspect, wherein the first microlens and/or the second microlens are arranged at random.

The microlens array according to the 16th aspect includes arranged microlenses sufficiently smaller than the length of one side of the effective region, wherein optical axes or optical axis surfaces of two vicinal microlenses are independent of each other, the optical axes or the optical axis surfaces of the microlenses are not close to the central points of the microlenses, but are located around the boundary of the microlenses, or externally and apart from the microlenses.

According to the 16th aspect, the rate of the portions at which an angle made by the eyes of the observer and the normal of the lens curved surface is large is high. Furthermore, the lens curved surface apart from the optical axes or the optical axis surfaces is used, thereby guaranteeing the performance of a lens.

Furthermore, since the optical axes of two vicinal microlenses are independent of each other, an image of each microlens can be prevented from being incorporated into a large image, and the microlenses can be prevented from being regarded as partially having larger dimensions.

The microlens array according to the 17th aspect includes an array of microlenses sufficiently smaller than the length of one side of the effective region, wherein the optical axes or the optical axis surfaces of two vicinal microlenses are independent of each other, and the boundary surface forming the microlens array including the virtual lens forming surface on which the microlenses are arranged is evenly and smoothly curved at the curvature radius sufficiently larger than the thickness of the microlens array.

According to the 17th aspect of the present invention, the curved microlens array allows the microlenses to be regarded as curved lenses having different distances from the optical axis depending on their positions in the microlens array. As a result, the focal lengths of the microlenses depend on their positions in the microlens array, and the parts of the entire display image are formed at different positions backward or forward depending on the focal lengths. However, the entire image is not enlarged or reduced in any direction. Furthermore, the distortion of the entire image by the curved microlens array is sufficiently small, and can be ignored.

Since the optical axes of two vicinal microlenses are independent of each other, images of the microlenses can be prevented from being integrated into one large image, or a part of the microlenses can be prevented from being regarded as getting larger in size.

The microlens array according to the 18th aspect of the present invention formed by microlenses sufficiently smaller than the length of one side of the effective region includes at least one of a region in which the focal lengths of the microlenses as well as the positions in the microlens array vary, and a region in which there are a plurality of groups of microlenses having different focal lengths, and the microlenses in each group have substantially equal focal lengths.

According to the 18th aspect of the present invention, since the focal lengths of the microlenses of the microlens array vary depending on the positions in the microlens array, the parts of the entire display image are formed at different positions backward or forward depending on their focal lengths. However, the entire image is not enlarged or reduced in any direction. Furthermore, the distortion of the entire image by the curved microlens array can be sufficiently small, and can be ignored. Since the optical axes of the two vicinal microlenses are independent of each other, an image of each microlens can be prevented from being incorporated into a large image, and the microlenses can be prevented from being regarded as partially having larger dimensions.

The display device according to the 19th aspect includes the microlens array according to the 18th aspect, and at least one of a two-dimensional display image and an image support for supporting the two-dimensional display image such that a two-dimensional display image can be opposed to the microlens array.

According to the 19th aspect, the display image formed through the microlens array shows that parts of the entire display image are formed at different positions forward and backward depending on the focal lengths of the microlenses of the microlens array. Furthermore, the entire image is not enlarged or reduced in any direction, and the distortion of the entire image by the curved microlens array can be sufficiently small, and can be ignored. Furthermore, the microlenses are not regarded as partially larger in dimensions, or it can be avoided that only a portion is abnormally enlarged or reduced.

The display device according to the 20th aspect includes a lens longer than 8 m in focal length, and a supporting unit for supporting the effective region of the lens at the position facing the eyes of the observer.

According to the 20th aspect, a display image, for example, a television receiver, a poster, etc., can be reduced or enlarged only by approximately 20% when it is viewed at the distance of 1.5 m from the normally closest position. When the focal length is longer, the rate of the enlargement or reduction can be lower. When the distance to a display image is longer, the rate of enlargement or reduction can be approximately 20% lower if the focal length can be longer. Therefore, the image can be viewed as a three-dimensional image without unnatural appearance. Furthermore, since the supporting unit maintains the position between the lenses and the eyes, the display image can be viewed following the movement of the head, etc.

The display device according to the 21st aspect includes a lens and a supporting unit for holding the lens such that the effective region of the lens can face the eyes of the user, and the eyes of the user can be set approximately 3 cm away from the lens, wherein the lens can have a focal length sufficiently longer than the distance between the eyes of the user and the lens.

According to the 21st aspect, the display image can be formed closer than the focal point, and the lens can be placed closer to the eyes than the image. Therefore, the display image is an erect image, and the position of the image is shifted from the position of the display image, thereby allowing the display image to be viewed as a three-dimensional image. Furthermore, since the lens is more than 3 cm apart from the eyes, the three-dimensional image can be more clearly displayed.

The lens according to the 22nd aspect includes a microlens array in which a plurality of microlenses having optical axes or optical axis surfaces independent of each other between adjacent microlenses in an effective region of a lens, and a support unit for holding the microlens array before the eyes of the user.

According to the 22nd aspect, the images compound by a plurality of microlenses form an entire image. Therefore, the entire image is not enlarged or reduced as with a single lend. In addition, since the supporting unit is provided, the lens moves with the movement of the head of the user, and a display image can be viewed through the lens without unnatural appearance.

The lens according to the 23rd aspect is based on the lens according to the 20th or 21st aspect, wherein it is a concave lens whose distance between the right and reverse curved surfaces is constant.

According to the 23rd aspect, since the lens has the structure obtained by curving a flat panel having a constant thickness, it is quite easy to produce a lens having a long focal length, thereby obtaining an inexpensive lens. Furthermore, by changing the thickness and the curving level, the focal length can be easily changed.

The microlens array according to the 24th aspect includes a plurality of microlenses sufficiently smaller than the length of one side of the effective region, wherein the plurality of microlenses have different focal lengths.

According to the 24th aspect of the present invention, since each microlens in the microlens array has a different focal length, parts of the entire display image can be formed at different positions backward and forward depending on the focal length. However, the entire image is not enlarged or reduced in any direction. Furthermore, the distortion of the entire image by the curved microlens array can be small enough to be ignored. In addition, since the optical axes of vicinal two microlenses are independent of each other, an image of each microlens can be prevented from being incorporated into a large image, and the microlenses can be prevented from being regarded as partially having larger dimensions.

The display device according to the 25th aspect includes the microlens array according to the 24th aspect, and at least one of a two-dimensional display image and an image support for supporting the two-dimensional display image such that a two-dimensional display image can be opposed to the microlens array.

According to the 25th aspect, the display image formed through the microlens array shows that parts of the entire display image are formed at different positions forward and backward depending on the focal lengths of the microlenses of the microlens array. Furthermore, the entire image is not enlarged or reduced in any direction, and the distortion of the entire image by the curved microlens array can be sufficiently small, and can be ignored. Furthermore, the microlenses are not regarded as partially larger in dimensions, or it can be avoided that only a portion is abnormally enlarged or reduced.

### BRIEF DESCRIPTION OF THE DRAWINGS

FIG. 1 is an oblique view of the display device according to the first embodiment of the present invention in which a microlens array including a number of semicylindrical microlenses is opposed to a two-dimensional display image;

FIG. 2 is an oblique view of the display device according to the second embodiment in which a microlens array including a number of microlenses having long focal lengths and having a boundary surface between a solid and a liquid as a lens surface faces a two-dimensional display image;

FIG. 3 is an oblique view of an microlens array according to the fifth embodiment of the present invention in which the microlens faces another microlens whose curvature radius is sufficiently larger than the curvature radius of the microlens;

FIG. 4 is a sectional view of the microlens array according to the 6th aspect of the present invention having a multilayer structure in which the optical axis surfaces of the cylindrical microlenses are independent of each other and parallel to each other.

FIG. 5 is a sectional view of the microlens array according to the seventh embodiment of the present invention including two types of microlenses, that is a convex lens and a concave lens;

FIG. 6 is a sectional view of the display device according to the eighth embodiment of the present invention including the lens curved surface away from the optical axis as a microlens;

FIG. 7 is a sectional view of the display device according to the ninth embodiment of the present invention including a microlens array having microlenses facing and inclined to the eyes of the observer;

FIG. 8 is a sectional view of display system according to the tenth embodiment of the present invention, in which the curved microlens array is opposed to the display image, viewed from the position of the eyes of the observer; and

FIG. 9 is a sectional view of the display system according to the eleventh embodiment of the present invention, in which a lens having an efficiently long focal length positioned close to the eyes and apart from the display screen, viewed from the position of the eyes of the observer.

### DESCRIPTION OF THE PREFERRED EMBODIMENTS

The embodiments of the present invention are described below by referring to the attached drawings.

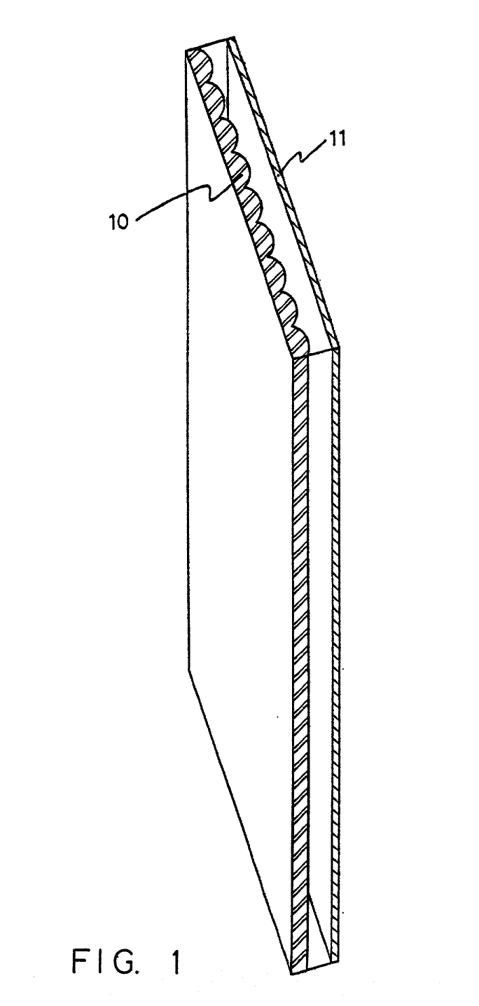

FIG. 1 is an oblique view of the display device according to the first embodiment of the present invention.

In FIG. 1, the display device comprises a microlens array 10, and an image support 11 for supporting display image of a pattern to be displayed. The display image can be either directly drawn on the surface of the image support 11, or drawn on paper, etc. and then fixed to the image support 11. According to the first embodiment, the image support 11 is a plate on which a display image is drawn such that it can face the microlens array 10. Although the image itself is omitted in FIG. 1, but is a two-dimensional image drawn as a well-known continuous pattern appearing in a common photo or a printed matter. Furthermore, the image support 11 is not always a plate, but can be a structure to be suspended holding a poster showing a display image.

In the above mentioned display device, the observer who observes a display image views a display image supported by the image support 11 or directly drawn on the image support 11 through the microlens array 10. The gap between the microlens array 10 and the display image is filled with air, that is, normal space.

On the image support according to an embodiment of the display device presented hereafter, either a display image is directly drawn, or a separately prepared two-dimensional display image such as a photo, a picture, etc. in the first embodiment unless otherwise specified. In addition, although a display image itself is omitted in the drawings, an image support and a display image is incorporated into one, and an image support can be represented as a display image.

The microlens array 10 is formed by a transparent portion, and a number of semicylindrical lenses are arranged with the convex surfaces facing outside. The central axes of the semicylindrical lenses are parallel to each other. The lens curved surface touches air, and has a form similar to a well-known lenticular plate. The display image is opposed to the microlens array 10 away from the lens curved surface of the semicylindrical microlens. The relationship among the position of the display image, the position of the image, and the magnification is described later using the equation including other embodiments. Qualitatively described below is the appearance of an image through the display device.

The entire display image is viewed as a group of the images of semicylindrical lenses. That is, the entire display image is generated using an image of a semicylindrical microlens as a new pixel. The image of a semicylindrical lens as a pixel can be formed at a position shifted from the position of the display image, and is transformed, that is, enlarged or reduced, etc. However, since the entire display image is a group of pixels of semicylindrical microlenses, it is not enlarged of reduced. Therefore, the entire display image appears to have been changed only in position with the size of the display image remaining as is. Therefore, as described above in the Background Art, the image can be viewed as a three-dimensional image through the optical illusion based on the adjusting function of eyes. The appearance of the image formed backward through the microlens array is common among all microlens arrays and the display devices using the microlens arrays, and the descriptions are omitted here.

The image support 11 has the function of determining the position relative to the lens curved surface of the display image, and easily replacing a display image.

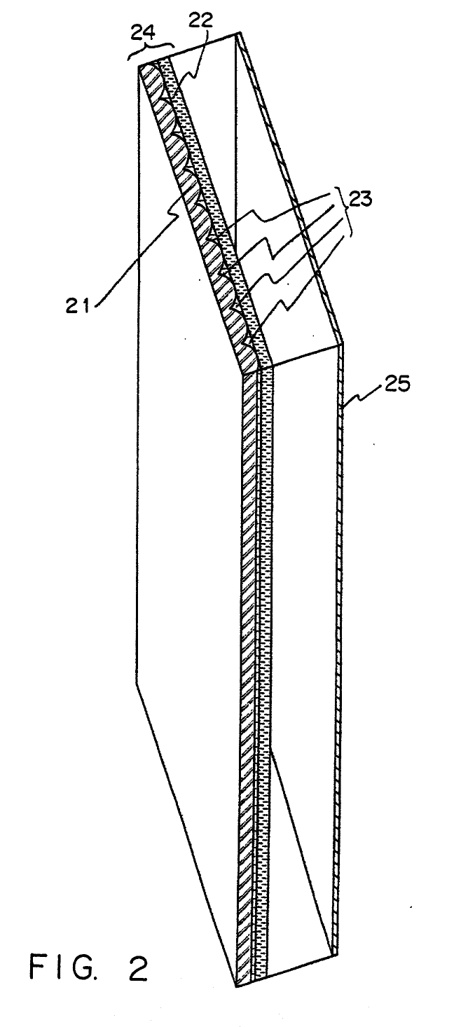

FIG. 2 is an oblique view of the display device according to the second embodiment of the present invention.

The second embodiment is obtained by improving the microlens array according to the first embodiment of the present invention, and controls the focal length by applying a transparent liquid on the lens curved surface of each semicylindrical lens.

In FIG. 2, a first transparent plate portion 21 is a transparent plate material having a number of semicylindrical projections facing outside. Another surface facing the surface on which semicylindrical microlenses of the first transparent plate portion 21 are arranged is a plane, and the first transparent plate portion 21 has a similar structure to the structure of an well-known lenticular plate. A second transparent plate portion 22 is a transparent plate portion opposed to the projections of semicylindrical microlens of the first transparent plate portion 21. A transparent liquid 23 is a transparent liquid inserted into the gap between the first transparent plate portion 21 and the second transparent plate portion 22. A container is formed by the first transparent plate portion 21 and the second transparent plate portion 22 such that the transparent liquid 23 cannot leak out. To prevent the evaporation of the transparent liquid 23 or the mixture of dust, the container is sealed. To attain this, the portions of the bottom, the lid, etc. are omitted in FIG. 2.

The curved surface forming each semicylindrical projection forms part of the surface of a lens. The first transparent plate portion 21, the second transparent plate portion 22, and the transparent liquid 23 form a microlens array 24 having an array of semicylindrical microlenses.

An image support 25 has the function of determining the relative positions of a display image and the lens curved surface, and easily replacing the display image.

The microlens array 24 corresponds to the microlens array 10, and the relationship between the microlens array 24 and a display image is the same as in the first embodiment of the present invention. The basic difference from the first embodiment is that the boundary surface to a liquid, not a gas, is a lens surface. As a result of the longer focal length of the microlens array 24, the position of a display image can be more freely set. Thus, the display device excels in configuration. The details are described later by presenting an expression of the lens.

According to the first and second embodiments, the microlens array is formed by semicylindrical microlenses, and the central axis of the semicylindrical lens is vertically set. The entire display image is viewed with the image of each semicylindrical microlens viewed as a pixel, and the array of the semicylindrical microlenses is freely set. The semicylindrical lens can be replaced with a hemispherical lens.

The small lens can be either a convex lens or an concave lens.

Hereinafter, the small lens forming part of a microlens array is referred to as a microlens.

The display device according to the present invention is described below by referring to the third embodiment of the display device applied to a window glass.

If a transparent plate unit having an array of a number of semicylindrical microlens projections faces a window glass, and a transparent liquid is inserted into the gap between the window glass and the transparent plate unit, then the transparent plate unit, the window glass, and the transparent liquid are to form a microlens array similar to the microlens array according to the first embodiment on the window glass. The circumference of the transparent plate unit is fixed to the window glass with an adhesive or a glue.

When a display image is placed behind the window glass provided with the microlens array through an image support, the display image appears as if it were a three-dimensional image. When the function of determining the distance from the lens curved surface is assigned to the image support, an adjustment can be easily made.

Thus, when a microlens array is incorporated into a window glass, there is no boundary surface of air between the outer side and the lens curved surface, thereby preventing large reflection generating with air defined as a boundary surface, and easily viewing a display image. Furthermore, the microlens array is incorporated into a window glass to form a simple structure.

Since the lens curved surfaces of the microlenses forming the microlens array are the boundary surfaces between the liquid and the solid, unlike the boundary surface to air, they make a longer focal length of the microlens, the distance between the lens curved surface and the display image can be larger, and allows light to directly radiate the display image, thereby reducing the reflection on the lens surface, and improving the lighting efficiency. In addition, it is not necessary to place a lighting appliance such as a lighting lamp. Furthermore, a user can be free of the reflected light on the surface of a lens, that is, the surface of a window glass, which interferes the sight.

Described below is the fourth embodiment of the display device according to the present invention using a medium having a refractive index sufficiently larger than air filled between the lens curved surface and the display screen of the microlens array.

The display device according to the fourth embodiment of the present invention is a transparent rectangular container having the first transparent plate portion according to the second embodiment as a side wall, and having the second transparent plate portion according to second embodiment as another side wall opposed to the above mentioned side wall.

Inside the above mentioned side wall, there are a number of semicylindrical projections of microlens forming a lens curved surface. The outside of the wall is a flat plane. The other side wall functions as an image support.

The above mentioned transparent container is filled with a transparent liquid. The above mentioned side walls and the transparent liquid form the microlens array on which microlenses are arranged. The transparent liquid can be water, glycerin, silicon oil, etc.

A display image is, for example, an image printed on a paper, and is laminated with a plastic sheet to keep off water. The plastic sheet directly touches the display image without space.

As clearly shown in the above mentioned configuration, the space between the lens curved surface of the microlens array and the display image is filled with a liquid or solid having a refractive index sufficiently higher than a gas. Therefore, since there is no boundary surface touching a gas having a large amount of reflection of light between the display image and the lens curved surface of the microlens array, there arises no large reflection around the boundary surface, thereby efficiently transmitting the light from the display image, and realizing a bright display. Furthermore, in the case of external illumination, it has no boundary surface touching a gas. Therefore, the light can be efficiently transmitted to the display image.

The view of the image using the display device according to the fourth embodiment of the present invention is described later in detail.

The display image soaked with a transparent liquid according to the fourth embodiment of the present invention can be applied directly to the outside of the container on the other side using a transparent glue or adhesive. In this case, it is necessary to avoid a gas layer between the above mentioned other side and the display image.

A three-dimensional image can be formed by disposing the display image outside the transparent container at some distance from the other side. However, in this case, there is an air layer before the display image, large reflection of light occurs at the boundary surface touching the air. In this case, the entire transparent container functions as a microlens array. On the other hand, when the display image is placed in the transparent container, and if it is applied to the outside of the other side using an adhesive agent, the portion up to the surface of the display image functions as a microlens array. That is, the microlens array forming portion forms a microlens array up to the boundary surface between the microlens and the air, or up to the surface of the display image.

It is obvious that the transparent liquid portion can be replaced with a solid material according to the fourth embodiment of the present invention.

Described below is the view of the entire image of the display image according to the first through fourth embodiments of the present invention.

The position of the display image relative to the position of the microlens is described below in detail by referring to the following equations.

Assume that a material having the thickness of d, and the absolute refractive index of n is represented as (d, n). Assuming that the materials (dₚ₁, nₚ₁), (dₚ₂, nₚ₂), (dₚ₃, nₚ₃), and (P, nₚ₄) are arranged in this order along the array of the lens curved surface, which is a boundary surface, and the display image, the display image is placed adjacent to the material (P, nₚ₄) with the thickness of P, the materials (dₛ₁, nₛ₁), (dₛ₂, nₛ₂), and (S, nₛ₃) are arranged in order from the lens curved surface in the direction opposite the display image, and the display image is formed adjacent to the material (S, nₛ₃) with the thickness of S. Then, the following equation (A) is effective. P and S indicate the distances from the boundary surface

1/(dₚ₁/nₚ₁+dₚ₂/nₚ₂+dₚ₃/nₚ₃+P/nₚ4)/(dₛ₁/nₛ₁+dₛ₂/nₛ₂−S/nₛ₃)=(nₚ₁−nₛ₁)/r (A)

where r indicates the curvature radius of the lens.

In the equation (A), when the distance P is positively reserved, and the distance S indicating the position of an image is positive, the distance is reserved from the lens curved surface in the direction of the display image. If the distance is negative, the distance is reserved from the lens curved surface in the direction opposite the display image. If the center of the curvature radius of the lens curved surface is closer to the display image than to the lens curved surface, then the curvature radius r of the lens curved surface is positively reserved. If it is on the opposite side, the distance is negatively set.

Since the thickness is sufficiently small, sufficiently smaller then the distances P and S, nₛ₃ is air and is approximately equal to the refractive index of vacuum of 1, the equation (A) is approximate to the following equation (B).

nₚ₄/P−1/S=(nₚ₁−nₛ₁)/r (B)

where np4 can be assumed to be the absolute refractive index of the material adjacent to the display image, and is therefore expressed by nₚ. The distance P is also the distance from the boundary surface touching the material on the side of the lens curved surface adjacent to the above mentioned material.

According to the first through third embodiments, the display image touches air. Therefore, nₚ=1.

Furthermore, when the thickness of the layer of the material facing the display image is sufficiently small, the layer can be ignored. For example, the display image is laminated by a thin plastic sheet, it can be ignored, and can be assumed to directly touch the material beyond the sheet.

The focal length can be the focal length fₚ on the side of the display image of the lens curved surface, and the focal length fₛ on the opposite side, and the following equations (C) and (D) can be derived from the equation (B).

fₛ=r/(nₚ₁−nₛ₁) (C)

fₚ=r·nₚ/(nₚ₁−nₛ₁) (D)

In the descriptions below, the focal length fₚ on the side of the display image expressed by the equation (D) is normally referred to as a focal length.

A positive focal length refers to a convex lens, and a negative focal length refers to a concave lens. It is clear from the equations that the focal length fₚ can be controlled by appropriately selecting the material on both sides of the lens curved surface.

According to the first through fourth embodiments of the present invention, one lens curved surface is used. However, it is well known that there can be a plurality of significant curved surfaces as lenses, and the focal length fₚ can be obtained by the following equation (E) if the lenses are arranged at a sufficiently short distance from each other and have matching optical axes.

1/fₚ=Σ(nₚ₁−nₛ₁)/nₚ·rᵢ (E)

where rᵢ, nₚᵢ, and nₛᵢ respectively refer to the curvature radius of the i-th boundary surface layer, the absolute refractive index of the material on the display image side, and the absolute refractive index of the material on the opposite side of the display image.

As is clear from the equation (E), assuming that the curvature radius of the microlens as a boundary surface having a lens curved surface is r, the absolute refractive index of the material on the display image side is nₚ, the absolute refractive index of the material on the opposite side of the display image is nₛ, the curvature radius of the other boundary surface which is not a lens curved surface facing the lens curved surface is R, the absolute refractive index of the material on the display image side is Nₚ, and the absolute refractive index of the material of the opposite side of the display image is Nₛ, the lens characteristic of the microlens of the microlens array is managed on the boundary surface of the lens curved surface, and the influence on the lens characteristic of the other boundary surface can be reduced if the following inequality (F) is effective.

|R/(Nₚ−Nₛ)|>>|r/nₚ−nₛ| (F)

When there are a plurality of significant lens curved surfaces in the microlens array, the lens curved surfaces of the microlens array collectively function as described above, and the focal length expressed by the refractive index of the material forming each boundary surface is obtained by the equation (E). Assuming that the focal length at each boundary surface is fᵢ (i indicates a natural number), and a total focal length is F, the following equation (G) is effective.

Σ(1/fᵢ)=1/F (G)

When the inequality (F) is effective between each lens curved surface and another boundary surface excluding all lens curved surfaces, it is obvious that the lens characteristic of the microlens array is managed on the boundary surface of the lens curved surface, and the influence on the lens characteristics of other boundary surfaces can be reduced.

Described above is the focal length when the thickness of the portion forming a lens is small. When it is too large to be ignored, the focal length fₚ can be obtained with the distance S set to the infinite, and the focal length fₛ can be obtained with the distance P set to the infinite based on the equation (A).

Although the thickness of the portion forming a lens cannot be ignored, it is obvious that the same basic characteristic as the case in which the thickness can be ignored can be obtained.

The optical axis of a microlens is clearly defined here. Normally, the virtual line connecting the thickest point on the lens to the center of the lens curved surface is defined as an optical axis. However, when the lens is inclines, the position of the thickest point is moved, and is not fixed. An embodiment of an inclined lens is described below, and the optical axis is defined without using the thickest point of the lens as follows.

An optical axis refers to a virtual perpendicular line from the center of the lens curved surface to the lens forming surface in the vicinity of the corresponding microlens.

The center of the lens curved surface refers to a central axis along the section perpendicular to the center of the sphere if the lens is a sphere, and to the central axis of the cylinder if the lens is a cylinder.

The optical axis surface is further defined below.

If a microlens is a spherical lens, its optical axis is linear. However, the microlens is a semicylindrical lens, a number of optical axes overlap on a single microlens, and a number of optical axes form a surface. Thus, a surface formed by a number of consecutive optical axes is defined as an optical axis surface.

The lens forming surface is a virtual surface obtained by predicting an average state of the concavity and convexity of microlenses, and the surface on which microlenses are arranged is a virtual lens forming surface.

Although a microlens array is flexibly set and curved, the array of microlenses can be practically and approximately regarded as a surface in a comparatively small area containing the microlenses. Therefore, the above defined optical axis can be applied.

The above defined optical axis and optical axis surface are applied to the entire specification of the present invention.

Described below is the optical axis, etc. when a microlens array is configured by laying a number of lens curved surfaces.

When a single lens curved surface is used, the optical axis of a microlens for which the boundary surface is between solids, or between a solid and a liquid is definite, that is, the optical axis of the microcurve surface of the lens curved surface is the optical axis of the microlens.

When there are a number of boundary surfaces which are significant lens curved surfaces, a compound lens formed by a synthetic optical system obtained by a number of microcurve surfaces of a plurality of lens curved surfaces can be regarded as a microlens which is a microlens array formed as a unit lens curved surface. Therefore, the compound lens can also be referred to as a microlens. When the word ‘compound’ is comprehensible, it is added in description.

When the microcurve surface of each lens curved surface has an equal area form, has the same positional relation to each other, and the optical axes have respective optical axes overlapping at the same positions, the focal length of the compound microlens can be easily obtained from the equations (E) and (G), and the optical axis matches the optical axis of the microcurve surface.

On the other hand, when the area form of the microcurve surface of each lens curved surface is different from each other, the portions overlapping each other function as new compound lenses. For example, if a lens curved surface is formed by two lens curved surfaces A and B, and if the microcurve surface c of the lens curved surface A overlaps the microcurve surfaces x and y of the lens curved surface B, then there arise a compound microlens formed by the overlapping portion between the microcurve surfaces c and x, and a compound microlens formed by overlapping portion between the microcurve surfaces c and y.

Although the optical axes of the microcurve surfaces in each lens curved surface are different from each other, the optical axis of any microcurve surface can be representatively regarded as the optical axis if the optical axes are parallel with each other and are arranged at a distance sufficiently smaller than the curvature radius of the microcurve surface. However, to be strict, each has its own optical axis. If the optical axes of the microcurve surfaces are independent of each other in each lens curved surface, the optical axes of the compound microlens are also independent of each other.

The microlens array according to the present invention normally can satisfy the above mentioned conditions. Although the above mentioned conditions cannot be satisfied in a special case, the microlens array can be regarded as being formed by a lens curved surface obtained by equivalently arranging compound microlenses. Obviously, the optical axis of the compound microlenses can be approximately determined.

There is no problem in referring to the compound microlenses simply as microlenses. The microlenses of a microlens array can be realized by a lens formed by a single boundary surface, or a lens formed by a number of stages of synthetic optical systems having a microcurve surface on a plurality of boundary surfaces. Furthermore, it can be assumed that a lens curved surface exists in the microlens formed by the number of stages of the synthetic optical systems. When the microlens array is sufficiently thin, the lens curved surface of each boundary surface can be regarded as a lens curved surface of microlenses formed by a number of stages of synthetic optical systems.

Any microlens array having a lens forming surface of the boundary surface between solids or between a solid and a liquid, not a surface touching a gas, and a microlens array obtained by laying a plurality of lens curved surfaces are regarded as an array of microlenses sufficiently smaller than the length of one side of an effective region.

One of the objects of the present invention is to provide a microlens array capable of controlling a focal length, and especially to have a long focal length. The lens characteristic can be determined by the conditions of the lens curved surface of the curvature radius r by satisfying the inequality (F), and the lens effects of other boundary surfaces can be ignored.

Conventionally, an effective and high quality lens has been produced with a boundary surface between a material of a large refractive index and air having a small refractive index. Although a layer of a material having a relatively large refractive index is inserted between the above mentioned materials, it is a thin coating material only. It is not the conventional concept of configuring a normal lens to design a lens of a long focal length under the condition of the inequality (F) using a boundary surface between two materials having similar refractive indices.

Since two materials can be selected, the focal length is not limited to the curvature radius, but can be controlled by relative refractive indices of both materials. Furthermore, since the difference between the refractive indices of both materials is small, the influence of a scratch on the lens curved surface can be reduced.

Described below is the view of the entire display image.

A display image is viewed by new pixels formed by each microlens. When the magnification of a microlens is smaller than 1, a part of the display image can be simultaneously viewed through adjacent microlenses. Therefore, the view of the entire image becomes unclearer with smaller magnification.

On the other hand, when the magnification is larger than 1, the portion smaller than the area of the microlens of the display image is enlarged, and the display image smaller than the area of the microlens appears as an image formed by the microlens. Therefore, a part of the display information is missing between adjacent pixels. When the amplification rate is 1, the images formed by adjacent microlenses are completely consecutive. However, the positions of the display image and the image match each other, and a three-dimensional image does not appear. In this case, it is not significant to use the microlens array.

Although a part of the display information is missing, the pixels look the more consecutive the lower the missing level is lower. Therefore, it is desired that the display image is placed at the position where a three-dimensional image can be viewed with the amplification rate close to 1 from the point of resolution.

Using a convex lens or a concave lens, a three-dimensional image can be viewed when the position of an image is somewhat shifted from the position of the display image. Then, the relationship between the position of a display image and an image is described below in detail using a convex lens and a concave lens.

First, the case using a convex lens is described.

When a display image is placed at a position closer to the lens curved surface than the position of the focal point, the image of the microlens is formed farther from the display image as a further enlarged erect image if it is the closer to the focal point. When the display image reaches the position of the focal point, the image appears at the infinite position with the infinite size. When the display image is placed at the position beyond and the closest to the focal point, a large enlarged inverted image is formed in the distance beyond the lens curved surface opposite the display image. When it is placed further apart, the inverted image is gradually reduced, and an inverted image of the magnification of 1 is formed when it is positioned at double the focal length. Then, if the display image is further apart, then the image is closer to the lens curved surface with the size of the image gradually reduced.

Before or after the focal point, the size and the position of the image greatly changes. Therefore, it is not desired to place the display image near the focal point from the viewpoint of the display quality of the display image. The focal point is positioned such that the magnification of the microlens is infinite in principle, thereby allowing only a part of the light of the display image to be used, and darkening the entire image.

When the display image is placed further beyond the focal point, the image is inverted, and the continuity of the images of adjacent microlenses is lost. Since the enlarged image is maintained up to double the focal length, a part of the display image does not overlap the images of the adjacent microlenses, and the quality of the display image can be maintained at a certain level. Furthermore, when it is placed at double the focal length, the image is reduced, thereby displaying the unclear entire image.

As described above, when a display image is placed apart from the lens curved surface of the microlens at double the focal length closer to the lens surface, and not very close to the focal point, the image is not unclear, and is relatively stable. Furthermore, if the display image is placed apart from the lens curved surface and closer to the focal point, and the continuity of adjacent pixels can be maintained at a higher level, thereby obtaining a stable display image with high resolution. If the display image is placed very close to the lens surface, a three-dimensional image cannot appear. The practical position can be determined depending on the requested level of the three-dimensional image and the smoothness level of the display image based on the pixels Described below is the case of a concave lens.

The position of an image is closer to the lens curved surface than to the display image, and an erect image of the magnification smaller than 1 is formed. The farther from the lens curved surface, the smaller the magnification. Thus, the position of the image becomes closer to the position of the focal point.

In the case of the concave lens, the image is reduced. Therefore, the entire image becomes unclear. As a result, it is necessary to control the unclearness level by limiting the position of the display image. For example, if the display image is set at the focal length, an erect image of 1/2 size is formed at 1/2 of the focal length. The reducing process forms an unclear image, but a three-dimensional image display device can be realized by setting the display image in the scope of acceptable unclearness.

The position of the display image has been described above by referring to the relationship between the position and the focal point or the focal length. Described below is the control of the focal length of the microlens array (microlens).

For the display device according to the present invention, the focal length has the following significance.

(1) It is necessary to configure the microlens array using a microlens of a long focal length on the following ground.

It is easier to have a three-dimensional image by setting a longer focal length, and setting the display image farther from the lens curved surface. Especially, when the image is viewed from a distance, this condition is requested. When the image is viewed from the short distance in the case of a personal computer monitor, etc., a three-dimensional image can be obtained by setting the lens curved surface of the lens having a short focal length of the microlens array at a short distance from the display screen. However, a higher quality three-dimensional image can be obtained by setting a somewhat longer focal length.

With a well-known lenticular plate which has a very short focal length, and with which the position of the focal point is set on the reverse side of the lens curved surface, the focal length is too short, a display image cannot be appropriately set, and a three-dimensional image cannot be obtained.

Furthermore, when the focal length is short, the positions of all points of a large display image cannot be easily maintained at the average position for the focal point. In addition, when the position is variable due to the wind, etc. and is closer to the focal point, or when it moves forwards and backwards relative to the focal point, the displayed image is unstable.

(2) Considering the unclearness of the entire image, a concave lens requires a focal length long enough to obtain a necessary difference in position between a display image and an image, and to obtain a desired three-dimensional image. The focal length should be long enough to obtain a three-dimensional image.

(3) To efficiently emitting the illumination light to the space formed between the lens curved surface and the display image according to the third and fourth embodiments, it is necessary to set the display image apart from the microlens array, and the focal length is to be set long.

(4) To easily replace a display image, the focal length is set long and the allowable scope of the position of the display image is to be larger.

(5) When a display unit is configured by applying a microlens array to a display device on which display pixels are regularly arranged, the level of the moire pattern occurring in association with the array pitch of the microlenses appears the more clearly when the display image is the closer to the focal point. To reduce the moire pattern, the focal length is set longer, and the display image is set apart from the focal point to obtain a clear three-dimensional image.

(6) If the microlens array is curved as described later, or is inclined, a more clear three-dimensional image can be formed. To attain this, the focal length is to be longer.

After recognizing the requests for the focal length, the control of the focal length of the microlens array is described below in detail.

To display the entire display image to be viewed through the microlens array according to the first through fourth embodiments as a clear consecutive image without unnatural appearance, the array pitch of the microlenses which is the base of the entire pixels has to be in an allowable scope. The allowable value depends on the requested precision, and also depends on the size of the display image on the display device, the distance from the display image to the observer. On the display device provided on the roof of a large building, the pitch of microlenses can be 10 mm. However, on the display device on a table, 1 mm is not allowed, but 250 μm can be required. Furthermore, the size of the pixel on the liquid crystal display can be about 100 μm. In this case, the array pitch of 100 μm or smaller can be requested.

It is very difficult to arrange microlenses having relatively long focal lengths at a high pitch.

Assuming that the boundary surface touching air is a lens surface, the array pitch is 250 μm using the material of the absolute refractive index of about 1.5, and the difference of the levels of the lens curved surfaces is 1/10 of the array pitch, that is, 25 μm, the curvature radius r is 0.325 mm, and the focal length fₚ is very small, that is, 0.65 mm only. This requires a very difficult process of placing a display image at an appropriate position.

According to the second through fourth embodiments, to solve the above mentioned problems, a long focal length is realized by arranging a material having a large refractive index instead of air touching the lens curved surface.

In the second and third embodiments, the microlenses of the curvature radius r of 1.13 mm are arranged at an array pitch of 1 mm on the material of the absolute refractive index of about 1.5, and a solution of glycerin and water as a transparent liquid. With the configuration, a focal length is obtained through trial computation. In the arrangement conditions of the lens, the level difference of the lens curved surface is 0.1 mm, and the focal length fₚ when air touches the lens curved surface is 2.26 mm.

When a transparent liquid is glycerin a 100 percent, the absolute refractive index is 1.47, and the focal length fₚ is 37.3 mm, that is, 16.6 times the value in the case where the boundary surface of the lens curved surface is air. If a small amount of water is added to glycerin to obtain the absolute refractive index of 1.45 for the transparent liquid, then the focal length fₚ is 22.6 mm, that is, 10 times the value in the case of air. When the 100% water of the absolute refractive index of 1.33 is used, the focal length fₚ of 6.65 mm. They all function as convex lenses.

As described above, the focal length can be increased by using a lens curved surface as a boundary surface of the material having a similar refractive index as described above, thereby furthermore easily controlling the focal length.

Although the material of one side of the boundary surface which is a lens curved surface of a microlens array is a transparent liquid, but it can be a transparent solid.

According to the third embodiment, a transparent unit having a lens curved surface attached to a window glass is used. However, it is obvious that a lens curved surface can be formed on a window glass. In addition, a liquid portion can be formed by a glue or an adhesive agent. That is, a lens curved surface is arranged facing the outer side of the window glass, and the space between the outer side of the window glass and the lens curved surface is to be filled with a transparent solid or a transparent liquid.

According to the first through fourth embodiments of the present invention, a clear three-dimensional image can be displayed. Each display image is a two-dimensional display image of consecutive patterns such as normal photos which are not complicated patterns obtained by dividing images viewed from a plurality of points into strips of image portions and arranging them, and the position of the display image is not close to the focal point with precision as in the LS display technology, thereby allowing it to be formed in a relatively large scope.

Described below is another embodiment of a microlens array according to the present invention.

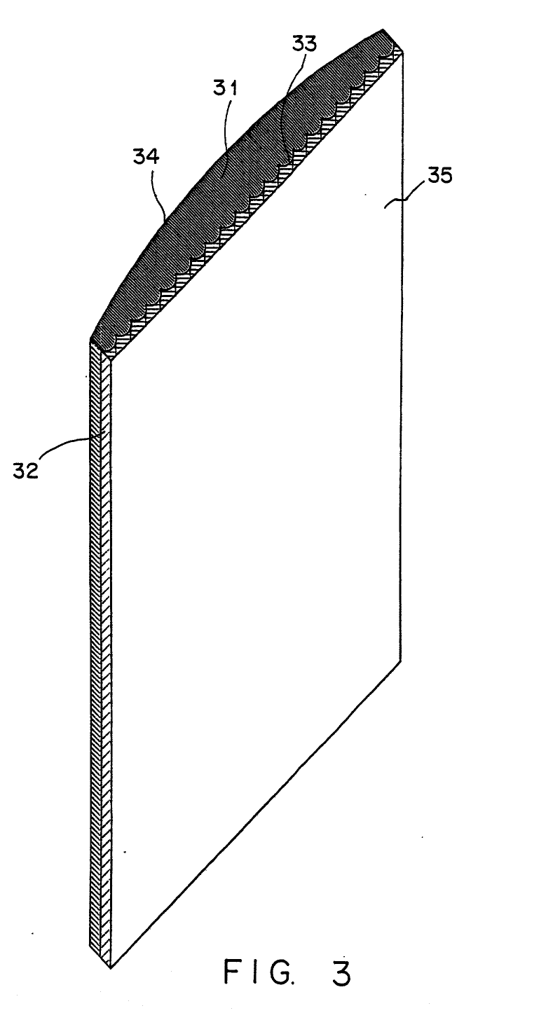

FIG. 3 is an oblique view of the microlens array according to the fifth embodiment of the present invention.

The microlens array comprises a first transparent unit 31 and a second transparent unit 32. One of the surfaces of the first transparent unit 31 is a microlens array surface 33 having an array of a number of semicylindrical projections. Another surface facing a microlens array surface 33 is a second lens curved surface 34 formed by a convex curved surface having a curvature radius sufficiently large than the curvature radius of the semicylindrical curved surface forming the microlens array surface 33. Like the microlens array surface 33, the second lens curved surface 34 is also a semicylindrical curved surface, and the central axis is parallel with the central axis of the semicylindrical lens curved surface of the microlens. The second transparent unit 32 is disposed close to the microlens array surface 33 of the first transparent unit 31. That is, the microlens array surface 33 is formed on the boundary surface between the first transparent unit 31 and the second transparent unit 32. Another surface 35 facing the microlens array surface 33 of the second transparent unit 32 is flat. In FIG. 3, to clarify the boundary of the semicylindrical projection of the microlens array surface 33, the portion viewed from the upper sectional portion of the second transparent unit 32 is clearly shown with the boundary.

By the existence of the second lens curved surface 34, the characteristic of each semicylindrical microlens array forming part of the microlens array surface 33 is equivalently changed.

By changing one of the curvatures of the microlens array surface 33 and the second lens curved surface 34, the integrated focal length can be controlled and changed. To efficiently control this process, it is desired that the focal length f₁ of the microlens array surface 33 and the focal length f₂ of the second lens curved surface 34 are almost equal to each other.

According to the fifth embodiment, the curvature radius of the microlens array surface 33 is sufficiently small than the curvature radius of the second lens curved surface 34. Nevertheless, the focal lengths f₁ and f₂ are almost equal to each other. That is, the first transparent unit 31 and the second transparent unit 32 forming the microlens array surface 33 are solids having almost equal refractive indices. One second lens curved surface 34 has a quite different refractive index from those of the solid and the gas on the boundary surfaces. Depending on the difference in the refractive index of the material on the boundary surface forming a lens curved surface, the focal lengths of the lens curved surfaces having quite different curvature radii are set almost equal.

With the above mentioned configuration, for example, by changing only the mold of a larger curvature radius, microlens arrays having different focal lengths can be obtained at relatively a low price.

According to the fifth embodiment of the present invention, the second lens curved surface 34 disposed facing the microlens array surface 33 is semicylindrical, but can be spherical. In addition, the entire effective region as a lens is a single and smooth lens curved surface, but can also be an array of plural lens curved surfaces in an effective region. In this case, the curvature is to be set such that the distortion of the entire image can be allowed, and the connection between lens curved surfaces is not to be a sudden difference, but is to be a smooth change. It is not necessary for a microlens curved surface forming the microlens array surface 33 to be a semicylindrical lens.

According to the fifth embodiment of the present invention, the other surface 35 of the second transparent unit 32 touching air is flat, but the surface an be a lens curved surface not touching air like the second lens curved surface 34.

As it is clear according to the fifth embodiment of the present invention, a set of microlens curved surfaces disposed at a short pitch sufficiently shorter than one side of an effective region is assumed to be a lens curved surface of the first type, and the lens curved surface having a curvature radius sufficiently longer than the curvature radius of the microlens curved surface forming the lens curved surface of the first type is assumed to be a lens curved surface of the second type. With the configuration, in a microlens array having at least one first type of lens curved surface facing at least one second type of lens curved surface, the total focal length can be adjusted by changing the curvature radius of one lens curved surface. With the configuration of the combination of the lens curved surfaces of the first type or the combination of the lens curved surfaces of the first and second types, a microlens array of various focal lengths can be relatively easily obtained.

It is not always necessary that the lens curved surfaces belonging to the first or second type have an equal curvature radius at the same array pitch, that is, they can be set arbitrarily.

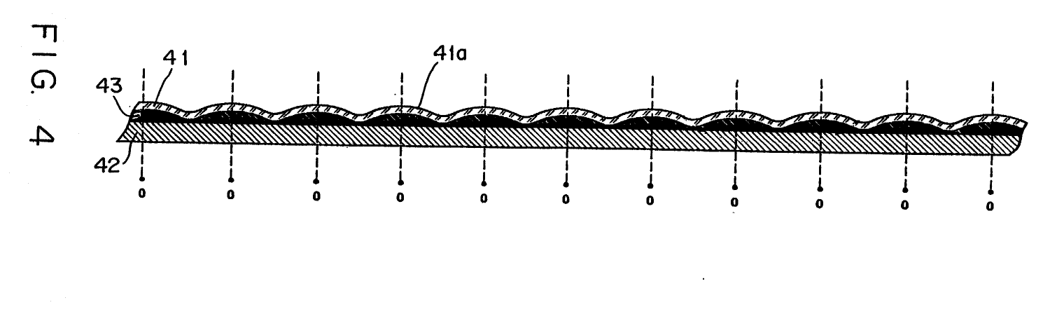

By referring to FIG. 4 showing the sectional view of the microlens array, the microlens array according to the sixth embodiment is described below.

In FIG. 4, the microlens array comprises a first outermost layer 41, a second outermost layer 42, and an inner layer 43 between the first and second outermost layers 41 and 42. The inner layer 43 is made of a material having a thermal softening point lower than the first and second outermost layers 41 and 42. In the microlens array according to the sixth embodiment, the semicylindrical lens having a lens curved surface of an outermost surface 41a of the first outermost layer 41 touching the air is a microlens. The other boundary surface has a small refractive index ratio or flat to be ignored. The microlenses are laid at short pitches. That is, FIG. 4 is a sectional view along the surface vertical to the axes of the semicylindrical lens curved surface of the microlenses. In FIG. 4, the optical axis of each microlenses is indicated by a dotted line.

The lens surface of the microlens is semicylindrical, and the microlens is long along the vertical direction of the paper form. The optical axis surface passes through the optical axis indicated by the dotted line, and is vertical to the paper form, and the optical axis surface of each microlens is parallel to each other.

The microlens array of the structure shown in the sixth embodiment obtained by inserting the inner layer 43 having a low thermal softening point between the first and second outermost layers 41 and 42 is an example of forming microlens curved surfaces by a number of boundary layers. The microlens array can easily be obtained in the method of heating and passing the lenses through the grooves on the roller made in the form of microlenses.

The display device capable of displaying a three-dimensional image using a microlens array has important characteristics as a display device that the focal length of a microlens array is long, the optical axis or the optical axis surface of a microlens is independent of each other, and the optical axis or the optical axis surface of a microlens is parallel to each other.

Since it has been described above that a long focal length is required, the importance of the independence and parallelism of the optical axes or the optical axis surfaces is described below.

It is important for a display device to be able to display an image with distortion minimized. When the optical axes of two microlenses close to each other are not independent of each other and share the same optical axis, the set of the microlenses is a part of a lens of a large area. When microlenses are distributed somewhat apart, very unnatural appearance does not occur. However, when microlenses are consecutive along the boundary, they form a single lens, thereby forcibly regarding the image formed by the set of microlenses as one pixel. That is, the pixel of only the portion is enlarged, a reduced or enlarged image is outstanding, and the quality of the display image is deteriorated. With an increasing number of these sets, the quality of the displayed image is deteriorated. The deterioration of the quality can be prevented by setting the optical axes of the microlenses independent of each other.

FIG. 4 shows the optical axis or the optical axis surface of each microlens by a dotted line. In FIG. 4, o shows the center of the lens curved surface of a microlens.

When the optical axes or the optical axis surfaces of two microlenses close to each other cross in the center between the lens curved surface and the display image, the relationship between the image of the microlens and the corresponding portion of the display image is inverted depending on up or down, or left or right.

If the optical axes or the optical axis surfaces of the two microlenses close to each other are parallel to each other on the lens curved surface when a microlens array is to be curved, then the distance from the lens surface to the point where the optical axes or the optical axis surfaces cross can be maximized, thereby realizing an easily curved microlens array. These hold true with all microlens arrays. In a microlens array formed by a boundary surface of a plurality of significant lens curved surfaces, two microlenses close to each other refer to a compound microlens in which a microlens array is configured by a lens curved surface of a single boundary surface. In addition, it can be a microlens having microlens curved surfaces on the same boundary surface as a lens curved surface. However, the microlenses which have different boundary surfaces are close to each other are not to be compared.

The importance of the independence of the optical axes or the optical axis surfaces of microlenses, and the parallelism of the optical axes or the optical axis surfaces of microlenses has been described above. However, it is not always necessary for microlenses to completely satisfy the descriptions above, but each effect can be obtained depending on each function and operation. Furthermore, the structure of the microlens array is not limited to a layer structure according to the sixth embodiment shown in FIG. 4, or the surface touching air is not limited to a lens curved surface, but they can be a boundary surface between solids, a lens curved surface which is a boundary surface between a solid and a liquid, a single material, etc.

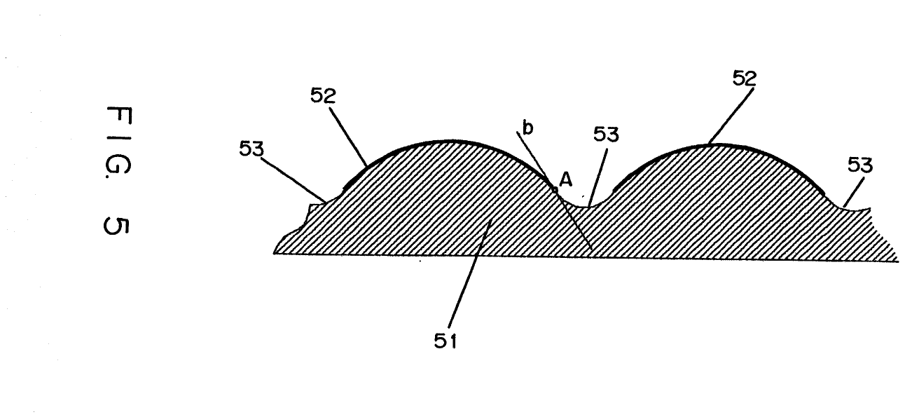

The microlens array according to the seventh embodiment is described below by referring to FIG. 5 showing the sectional view of a microlens array.

In FIG. 5, a microlens array 51 comprises a convex lens portion 52 indicated by a bold line, and a con cave lens portion 53 indicated by a thin line. These convex lens portion 52 and concave lens portion 53 are microlenses forming the microlens array 51. They are respectively referred to as a convex microlens 52 and a concave microlens 53.

The point A shown in FIG. 5 is a point typically indicating the joint between the convex microlens 52 and the concave microlens 53, and the line b indicating the surface touching a lens curved surface is smoothly extended at the point A.

The convex microlens 52 and the concave microlens 53 forming the microlens array 51 touch each other at the boundary, and two convex microlenses or two concave microlenses do not touch each other as adjacent lenses with their contact surfaces indicating a sudden change. When two convex microlenses or two concave microlenses touches each other with their lens curved surfaces smoothly touching each other, they can be newly regarded as a convex lens or a concave lens.

The lens curved surface of the convex microlens 52 of the concave microlens 53 can be variable in curvature radius depending on the position of the internal position. It is obvious that each convex microlens 52 or concave microlens 53 can be equal to each other in curvature radius in the entire internal area, and can be a lens sharing the same optical axis.

The flat surface portions as a result of equally dividing a lens curved surface into convex or concave curved surface belong to the convex microlens 52 or the concave microlens 53.

When a microlens array is configured only by the convex microlens 52 or the concave microlens 53, the lens curved surface shows a discontinuous line at the boundary of the microlenses, and the display images are discontinuous.

An image formed by the convex microlens 52 is an enlarged image, and only a part of the display image of the convex microlens 52 can be displayed through the convex microlens 52. Therefore, when the convex microlenses 52 touch each other, a part of the display image corresponding to the boundary portion of the convex microlens 52 is missing in the display, thereby failing in displaying a continuous display image.

On the other hand, an image formed by the concave microlens 53 is a reduced image, and a corresponding part of the image of the adjacent concave microlens 53 beyond the concave microlens 53 of the display image is displayed as an image. Therefore, when the concave microlenses 53 are adjacent to each other, a part of the display image corresponding to the boundary portion of the concave microlens 53 is displayed as the image of the adjacent concave microlens 53, thereby failing in displaying a continuous display image.

Thus, to prevent a discontinuous lens curved surface in the microlens array comprising a number of convex microlenses 52 or concave microlenses 53, the curved surfaces of the convex lens and the concave lens are required, and the curved surfaces of the convex lens and the concave lens have to alternately touch each other.

According to the seventh embodiment, the convex microlens 52 and the concave microlens 53 touch each other in the microlens array 51. Furthermore, the touching surfaces of the convex microlens 52 and the concave microlens 53 match at the boundary, and the lens curved surfaces smoothly continue. Therefore, the portion of the display image missing as an image formed by the convex microlens 52 is compensated for by the image formed by the adjacent concave microlens 53, thereby preventing a missing or overlapping display image by forming a continuous image by the convex microlens 52 and the concave microlens 53.

If one of the lens curved surface of the concave microlens 53 and the lens curved surface of the convex microlens 52 is regarded as the lens curved surface of a microlens, then the other lens curved surface can be regarded as a boundary portion for connection of microlenses. The microlens (for example, the concave microlens 53) can be assumed to be connected through a boundary portion having the opposite lens characteristic (convex microlens 52). The lens curved surface of the microlens is a continuously smooth curved surface.

Described below is the display device in which the microlens array 51 is provided before the display screen.

When the microlens array 51 is configured only by the convex microlens 52 or the concave microlens 53, the boundary surface between the convex microlens 52 and the convex microlens 52 (or the boundary surface between the concave microlens 53 and the concave microlens 53) shows a sudden change, thereby causing great disturbance to the entire image. Especially when high precision display is to be performed, the shorter array pitch of the convex microlenses 52 (or the concave microlenses 53), the higher rate of boundary portions, thereby deteriorating the quality of a display image.

In the case of the microlens array 51 configured by only the convex microlenses 52 or the concave microlenses 53, a display image cannot be continuously displayed, thereby deteriorating the quality of the image.

In the present invention, the lens curved surface is smoothly extended, and therefore the portion of the display image which cannot be formed by the convex microlens 52 can be compensated for by the adjacent concave microlens 53, and the lens curved surface can be smoothly extended at the boundary between the convex microlens 52 and the concave microlens 53. As a result, the problems of a low quality image that a part of a display image is missing, a part of a display image is overlapped, etc. can be reduced.

With the combination of the convex microlenses 52 and the concave microlenses 53, one is regarded as a microlens, and the other as a boundary portion. If the area of the boundary portion is reduced, the lens curved surface suddenly changes in a small area. If the area is too small and the lens curved surface is curved, then the focal length is shortened, and causes the disturbance of the entire image. It is the same as the case in which only the microlenses having the same lens characteristic are arranged. That is, as in the case in which other microlenses do not exist, a display image is disturbed.

By adjusting and optimizing area ratio of the concave lenses and the convex lenses, the curvature of the lens curved surface, etc. as necessary, the deterioration of the quality of an image can be reduced to obtain a microlens array as a filter for a three-dimensional image.

If the magnification of enlarging or reducing an image formed by microlenses is intensified, it causes the deterioration of the quality of an image displayed on the display device. Therefore, by setting the display image apart from the focal point and closer to the lens curved surface, the magnification of enlarging or reducing the image formed by the microlenses can be reduced, thereby improving the quality of the image. In this case, the level of a three-dimensional image may be lowered, and the quality can be totally controlled including the disturbance of an image under the appropriate condition.

When the display image displayed on the electronic display on which display pixels are regularly arranged is viewed through the microlens array, a moire pattern is detected. If images formed by lenses which can be regarded as a boundary portion continuously appear as in the present invention, the moire pattern can be reduced. Furthermore, when the microlenses are arranged at random, abnormal conditions such as the distortion of microlenses do not linearly appear, but are scattered, thereby successfully reducing the linear distortion such as the moire pattern on a display image.

According to the seventh embodiment of the present invention, the microlens array is made of a single material, but the microlens array can be, as in the sixth embodiment of the present invention, made of a plurality of layers.

If the microlens array according to the fifth through seventh embodiments described above replaces the microlens array according to the first or second embodiment, and is set before the two-dimensional display image, a display device capable of displaying a three-dimensional image can be realized.

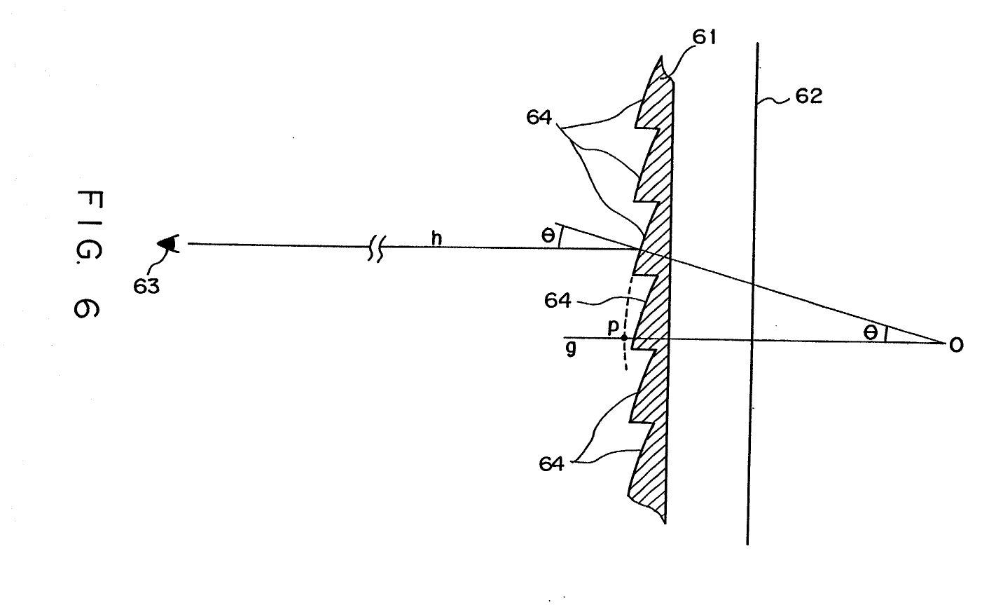

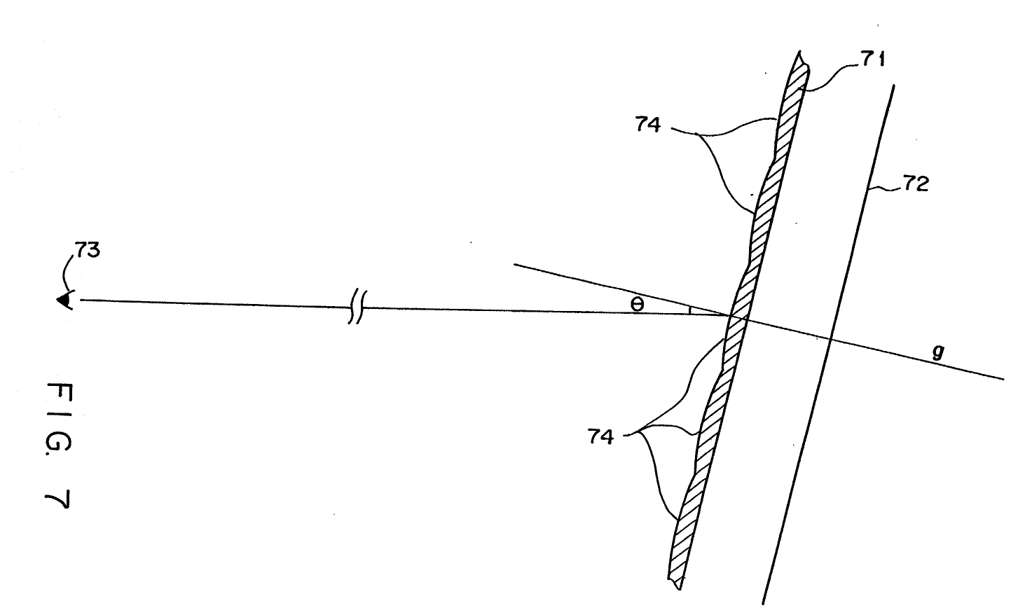

In the display device for displaying a high precision display image, a microlens array with microlenses arranged at high density is required. When the array pitch of the microlenses is set short by setting the focal length of the microlenses to a constant value, only a part of the curved surface of a long radius has to be used as a lens curved surface. When the eyes of the observer are set vertical to the lens curved surface, the lens curved surface almost reaches a plane surface, thereby reducing the function of the lens. the effective display device according to the eighth and ninth embodiments of the present invention are described below in detail by referring to FIGS. 6 and 7.

FIG. 6 is a sectional view of the display device according to the eighth embodiment of the present invention.

In FIG. 6, the display device comprises a microlens array 61 comprising microlenses 64, and an image support 62 for supporting a display image containing a pattern to be displayed. The space between the microlens array 61 and the image support 62 is filled with air as a normal space.

The lens curved surface of the microlenses 64 configuring the microlens array 61 is a semicylindrical surface. The optical axis of each microlenses 64 passes through the virtual lens curved surface obtained by extending the lens curved surface of the microlenses 64 as indicated by the straight line g shown in FIG. 6.

The optical axis or the optical axis surface of the two vicinal microlenses 64 are independent of and parallel to each other.

Normally, excluding the case in which the microlens array is intentionally curved, the microlens array is flat, and is opposed to the observer. The eyes of the observer are vertical to the lens forming surface, and the eyes of the observer match the optical axis. In this case, the observer is assumed to be sufficiently apart. Thereafter, unless otherwise specified, the observer is assumed to be sufficiently apart.

According to the eighth embodiment of the present invention, the lend forming surface is flat and facing a display image in parallel. An observer 63 correctly faces the display image with the above mentioned configuration, and views the display image supported by the image support 62 through the microlens array 61, or the two-dimensional image directly drawn on the image support 62. The optical axis of each microlenses 64 is representatively indicated by g in the attached drawings, and the virtual curved surface indicated by the dotted line in the attached drawing as an extended lens curved surface crosses the optical axis g at the intersection p.

The true lens curved surface of the microlenses 64 forming the microlens array 61 is apart from the optical axis g. Therefore, the angle θ made by the optical axis g and the normal i at an arbitrary point is a value large enough to a certain extent.

The eyes h of the observer 63 sufficiently apart are parallel to the optical axis g, and the angle θ made by the eyes h of the observer 63 and the normal i at an arbitrary point on the lens curved surface can be large enough. As compared with the case in which the optical axis g is positioned at the center of the microlenses 64, the light from the display image is sufficiently refracted on the entire area of the microlenses 64 and reaches the observer 63, thereby definitely functioning as a lens.

The eighth embodiment of the present invention is an example that the intersection p of the lens curved surface (virtual curved surface) and the optical axis g is externally located apart from the true lens curved surface of the microlenses 64. Although the intersection of the lens curved surface and the optical axis is still inside the true lens curved surface, and is positioned apart from the central portion of the microlens, the area in which a microlens forms a sufficiently refracted image can be extended as compared with the case in which it is positioned in the central portion, thereby definitely functioning as a lens.

Thus, if the intersection of the lens curved surface and the optical axis is set apart from the center of the microlens, there arises a level difference at the boundary between microlenses. In FIG. 6, it is shown as a step-formed difference. However, there arises a certain inclination under the actual production conditions. Furthermore, a moderate change can be made to improve the quality of an image. In any case, the boundary portion can be limited to a very small scope.

Described below is the display device according to the ninth embodiment of the present invention by referring to FIG. 7.

FIG. 7 is a sectional view of the display device according to the present invention.

In FIG. 7, the display device comprises a microlens array 71 configured by microlenses 74, and an image support 72. The microlens array 71 is flat, and the lens curved surface of the microlens 74 is semicylindrical and symmetric about the optical axis. The relationship between the microlens array 71 and the display image is the same as in the eighth embodiment described above by referring to FIG. 6.

The basic difference between the ninth embodiment and the eighth embodiment described above by referring to FIG. 6 is the difference in array state of the microlenses 74 forming the microlens array 71, and the difference in direction (angle) to an observer 73.

The microlenses 74 are arranged to be symmetric about the optical axis g.

As in the eighth embodiment, the microlens array 71 is opposed and parallel to the image support 72. The display device with the above mentioned configuration is disposed such that the microlens array 71 is opposed to the observer 73 at the inclination angle of θ. Obviously, the lens forming surface and the image support 72 are opposed to the observer 73 at the inclination angle of θ. The observer 73 views the display image supported by or drawn on the image support 72 through the microlens array 71. In this case, the eyes of the observer 73 are inclined by the angle of θ from the optical axis g of the microlens 74.

If the eyes h are inclined by the angle of θ from the optical axis g, the angle between the eyes h and the normal of the lens curved surface of the microlens changes by θ as shown in the attached drawing. That is, the incident angle of the eyes h to the lens curved surface changes by θ. Both θ and β are signed values based on the optical axis g. The angle made by the eyes h and the normal of the lens curved surface of the microlens is expressed by (β−θ) which is expressed as a signed value. Hereinafter, the angle made by the eyes h and the normal of the lens curved surface of the microlens is referred to as an angle made by the eyes and the microlens for short. An absolute value of the angle made by the eyes and the microlens is important for the function as a lens, and the sign + or − has no significant meaning. Therefore, unless otherwise specified, the angle made by the eyes h and the normal of the lens curved surface of the microlens is expressed by an absolute value.

When an angle made by the lens and the eyes is increased for one of the areas separated by the optical axis, the angle is decreased for the other area.

In the ninth embodiment in which the optical axis g is at the center of the microlens, the angle made by the eyes and the microlens can increase or decrease in the area where θ is a small value. However, in the microlens, there are a number of areas where the angle is increased, and the ratio of the area where the angle is increased to the area where the angle is decreased is high. When the value of θ is furthermore larger, the value of θ increases in all areas of the microlenses, and the angle made by the eyes and the microlens increases.

On the other hand, when the optical axis is not in the center of the microlens, that is, when it is out of the center inside the microlens, or when it is outside the microlens, the rate of the area of microlenses having large angle made by the eyes and the microlenses increases or decreases depending on the tilt direction of the microlenses.

When the angle made by the eyes h and the normal of the lens curved surface becomes larger, the light more largely refracted than on the microlens 74 reaches the observer 73, thereby guaranteeing the functions of the microlens 74 as a lens.

In the explanation above according to the ninth embodiment, the microlens 74 is inclined along the slant direction of the lens for the observer 73. When the axis of the semicylindrical lens normal to this is inclined along the observer, the angle made by the eyes of the observer and normal of the lens curved surface increases, thereby guaranteeing the functions of the microlens as a lens, and obtaining a clear three-dimensional appearance.

As clearly described above according to the ninth embodiment of the present invention, the microlens array 61 according to the eighth embodiment of the present invention can be assumed to be configured such that the microlenses 64 is 5 inclined along the slant of the lens in advance. It is not necessary to always incline the microlens array 61 to the observer 63 according to the eighth embodiment of the present invention, but the microlens array 61 can be inclined to the observer 63 such that the angle made by the eyes and the normal of the lens curved surface can be large enough.

According to the ninth embodiment, the microlens array 71 and the image support 72 are arranged as inclined to the observer 73. However, a display image can be inclined to the microlens array 71 by, for example, setting the display image facing to the observer 73. That is, the relationship between the microlens array 71 and the observer 73 is important, and the relationships between the microlens array 71 and the display image, and between the observer 73 and the display image are not important.

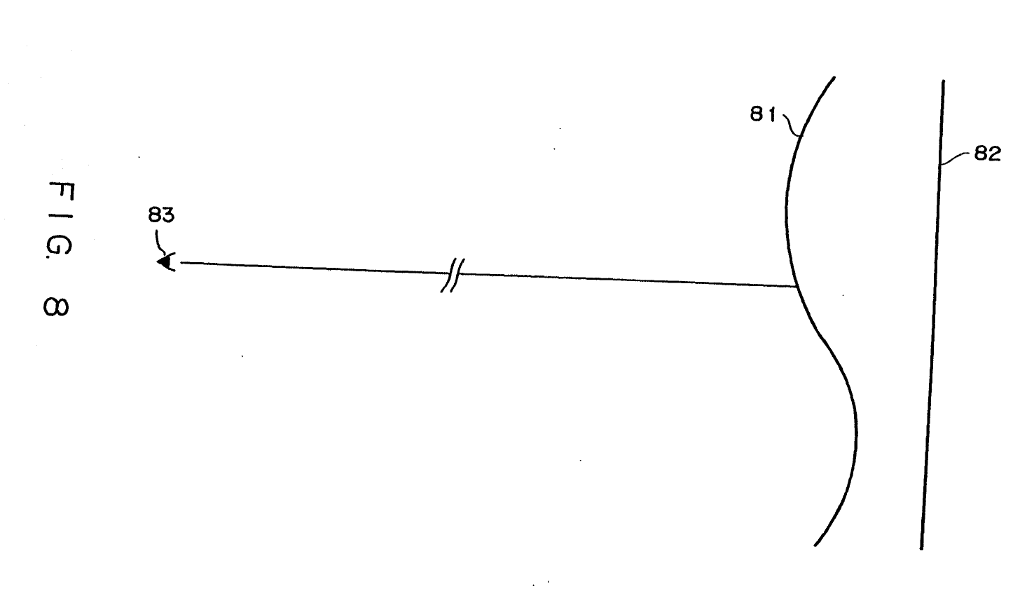

The tenth embodiment of the present invention is described below by referring to FIG. 8.

The tenth embodiment of the present invention is opposed to the observer and the display screen with the microlens array curved.

FIG. 8 is a sectional view of the display device according to the tenth embodiment of the present invention.

In FIG. 8, the display device comprises a microlens array 81 sufficiently smaller than the length of one side of an effective region, and an image support 82 for supporting the display image of a pattern to be displayed. The lens curved surface of the microlens configuring the microlens array 81 has a semicylindrical surface, and is long in the direction vertical to the surface of the drawing. The microlens is symmetric about the optical axis as according to the ninth embodiment of the present invention. The individual microlenses are omitted in FIG. 8.

An observer 83 is to view the two-dimensional display image supported by the image support 82, or the two-dimensional display image directly drawn on the image support 82.

The microlens array 81 is thin and flexible against bending, opposed to the image support 82, and curved as a curved surface of a curvature radius sufficiently larger than the array pitch of the microlens, and the thickness of the microlens array 81.

Before the microlens array 81 is curved, it has the same structure as the microlens array 71 of the ninth embodiment of the present invention. The lens curved surface of the microlens 84 is semicylindrical, and the lens is long in the direction vertical to the surface of the drawing. The microlens is symmetric about the optical axis.

The thin microlens array 81 is curved with the similar curvature radius not only on the virtual lens forming surface of which the microlens is arranged but on all boundary surfaces contained in the microlens array 81 containing the boundary surface touching the outside air. Therefore, the entire image containing the display image arranged closer to the microlens array 81 than the curvature radius of the curve and viewed through the microlens array 81 has little distortion generated by the curve of the microlens array 81, or the entire image of the display image does not appear partially distorted. This can be easily be understood by the fact that the distortion by a curve can be ignored although a flat film sheet is curved. This is because bending on a boundary surface can be offset by inversely bending on another boundary surface, thereby reducing the refraction of light by the curve of the entire microlens array 81.

However, each part of the microlens array 81 has a different slant level in each position, and the lens curved surface of the microlens has its own slant angle depending on the position.

Thus, if the microlens array 81 is curved, a more apparent three-dimensional effect can be realized. This is apparent as a fact, and always takes place on any of a semicylindrical lens, a spherical lens, etc. regardless of the concave lens or the convex lens, or the direction of the curve.

Since the lens curved surface of the microlens in a different position on the microlens array 81 can be considered to have a different position from the optical axis, the focal length of the microlens depends on the position on the microlens array. As a result, each portion in the entire image of a display image has a different position in the depth direction. That is, the entire image is distorted in the depth direction, thereby realizing a clear effect of displaying a three-dimensional image. The distortion hardly appears on the entire image. That is, since the entire display image has pixels of microlenses, the entire image is not enlarged or reduced in the horizontal or vertical directions, but each part of the entire image has its own position in the depth direction. The difference in position in the depth direction is not recognized as the apparent distortion of the entire image, but is unconsciously stored in the brain of the observer who views the image as a three-dimensional image.

In the description above, the cause of the distortion in the depth direction of the entire image is the difference in focal length of a microlens. However, there also is an additional effect of changing the position of an image by the change of the relative position between the microlens and the display image depending on the position on the curved microlens array.

By curving the microlens array 81, the angle made by the eyes of an observer and the microlens becomes large. Thus, the function of the microlens can be guaranteed as the inclined microlens array 81 according to the second embodiment. Additionally, the focal length can be controlled by changing the curving level.

In the tenth embodiment described above by referring to FIG. 8, the curve of the microlens array 81 changes the focal length of the microlens depending on the position on the microlens array. However, if the focal length of the microlens of the microlens array 81 has Ben changed in advance depending on the position on the microlens array, the similar effect can be obtained without curving the microlens array 81. There are means for changing the curvature radius of the lens curved surface of a microlens, and means for changing the refractive index of one or both of the materials forming the boundary surface of the lens curved surface with the curvature radius of the lens curved surface of the microlens fixed. Furthermore, there is means for arranging lens curved surfaces having different focal lengths from the optical axis.

According to the tenth embodiment of the present invention, for example, each of the concave and convex portions is provided on the curve of the microlens array 81 is provided. The curvature radii of the curve are different between the convex and convex portions. Assuming that the cycle of the curve starts and ends at the peaks of the adjacent convex portions or at the bottoms of the adjacent concave portions, the curve in an effective region can be a fraction or several fractions of the curve. The cycle and the curvature radius can depend on each curve. It is designed such that the brain of an observer 83 can unconsciously recognize a change of a part of the entire image in the depth direction. An appropriate curve can be set depending on the display status such as the distance between the observer 83 and the display image, etc.

Although the microlenses according to the eighth through the tenth embodiments of the present invention are semicylindrical, they have been described above by referring to an optical axis. However, they are to be described by referring to an optical axis surface. On the other hand, a spherical lens is to be described by referring to an optical axis, not an optical axis surface.

Furthermore, in the eighth and ninth embodiments of the present invention, the lens curved surface of a microlens in the microlens array is described as a single boundary surface touching air.

It is obvious that the above mentioned microlens array can be replaced with a microlens array having a lens curved surface of microlenses as a boundary surface between solids or between a solid and a fluid, or a microlens array obtained by laying a plurality of lens curved surfaces. It is obvious that the microlens array 81 according to the tenth embodiment can be used for the above mentioned microlens arrays.

Described below is the change depending on the position of the focal length for realizing a clear three-dimensional image according to the tenth embodiment of the present invention.

A clear three-dimensional image can be realized if a microlens array is configured in an area in which the focal length of a microlens gradually changes with the position. The change can be smooth or show a small increase or decrease. Furthermore, a sharp change in a range smaller than the number of microlenses can be acceptable. For example, microlenses having almost equal focal lengths continue to a certain extent, a change occurs at a point, other microlenses having almost equal focal lengths continue to a certain extent, a change occurs again in focal length, and further microlenses having almost equal focal lengths continue again. Thus, a clear three-dimensional image can be realized with the configuration of the microlens array in an area where groups having different focal lengths is distributed. There are at least two types of groups having different focal lengths, and there can be three or more types. The changes between the groups having different focal lengths can be moderate or sharp.

A number of microlenses having different focal lengths can be distributed in a group.

It is obvious that a clear three-dimensional image can be realized when an area in which the focal length of a microlens gradually changes with its position is combined with an area in which groups having different focal lengths are distributed. The level of a change, the intervals of changes, etc. depend on the size of a display image, the array pitch of microlenses, the level of the appearance of a requested three-dimensional image, etc. It is necessary that the focal lengths of microlenses in the effective region of the microlens array are not constant, but change depending on their positions. Obviously, it is not necessary that the focal lengths change in the entire effective region.

If it is assumed that one lens is defined as a microlens in the microlens array obtained by alternately arranging the convex lenses and concave lenses according to the seventh embodiment, then the other lens can be a connecting portion between microlenses. Thus, adjacent convex and concave lenses can form a microlens with the above mentioned change of focal lengths, thereby realizing a clearer three-dimensional image.

The above mentioned microlens array in which focal length changes depending on the positions of microlenses can be easily obtained with the configuration in which the lens curved surface is a boundary surface between solids, or with the configuration in which the lens curved surface is formed by a plurality of boundary surfaces.

The change depending on the position of a microlens array having the above mentioned focal length can be realized by changing the material forming the boundary surface which is a lens curved surface. Furthermore, when layers of two types of materials having different refractive indices as liquids when they are produced are alternately arranged, the materials are mixed with each other around the boundary surface portion, thereby continuously changing the refractive indices, and forming a microlens array moderately changing its focal length around the material mixed portion.

If there are at least two significant lens curved surfaces A and B as boundary surfaces with a microcurve surface of a microlens formed on one surface A and with lenses having radii larger enough than the microlens scattered on the other surface B, then the lenses on the surfaces A and B are mixed with each other to form a microlens array in which microlenses having different focal lengths are distributed. They are examples, and various microlens arrays can be formed with different focal lengths depending on the positions of the lenses by arranging various lenses on a plurality of boundary surfaces in various distribution states.

In the first through tenth embodiments, the microlenses forming a microlens array are semicylindrical lenses, but they can be spherical lenses. It is not necessary to keep uniform areas. Additionally, a complete lens is not always required. The precise semicylindrical or spherical surface is not strictly required. When the integrity of a lens curved surface is lost, the focal position changes depending on the position inside the lens, but it can be regarded as an inferior lens, the central position of each focal point can be regarded as a focal point, or the closest or farthest focal position can be appropriately regarded as a focal position, thereby designing a display device. Since the entire image of the display image is recognized using images of microlenses as pixels, there are no problems although the image of a microlens as a pixel is a little distorted. The conditions of the above mentioned microlenses are applied to all of the above mentioned microlens arrays.

When a microlens array is curved, and the microlenses are semicylindrical, the semicylindrical lenses can be formed by a number of small semicylindrical lenses.

In the first through tenth embodiments of the present invention, the lens curved surface of a microlens is a single surface touching air in many cases. Although a lens curved surface is a boundary surface between solids or between a solid and a liquid, or when a plurality of lens curved surfaces are laid, the same effect can be obtained.

With the above mentioned display device, the display image can be regarded as an array surface of a display image of a Braun tube for systematically and regularly displaying small display pixels, an electronic display such as an LCD, etc.

With the display image obtained by regularly arranging the above mentioned display pixels at predetermined intervals, a moire is generated when a microlens array obtained by arranging microlenses are regularly arranged at predetermined intervals is used. The moire is well known, and the detailed explanation is omitted here. The moire does not occur when there is an integer function between the array pitch of microlens of a microlens array and the array pitch of the pixels of the display elements. In this example, the integer function refers to ‘the relationship of the intervals of a multiple of a positive integer of one array pitch corresponding to the intervals of a multiple a positive integer of the other array pitch’. When the relationship is effective, the moire can be suppressed.

It is effective that microlens of different sizes are arranged at random. For example, if a microlens is semicylindrical, microlenses having different widths can be arranged at random. It is not necessary that they are arranged completely at random, but can be arranged in a pseudo random array. In this case, it is desired that the focal length of each microlens is equally set, but a small difference is acceptable. The focal length of the microlens array can be, for example, an average value, the minimum value, the maximum value, or a value obtained by determining an allowable range for the focal length of a microlens. That is, the focal point or a focal length of a microlens array can be determined as the quality of a display image which is important relating to the position of the display image.

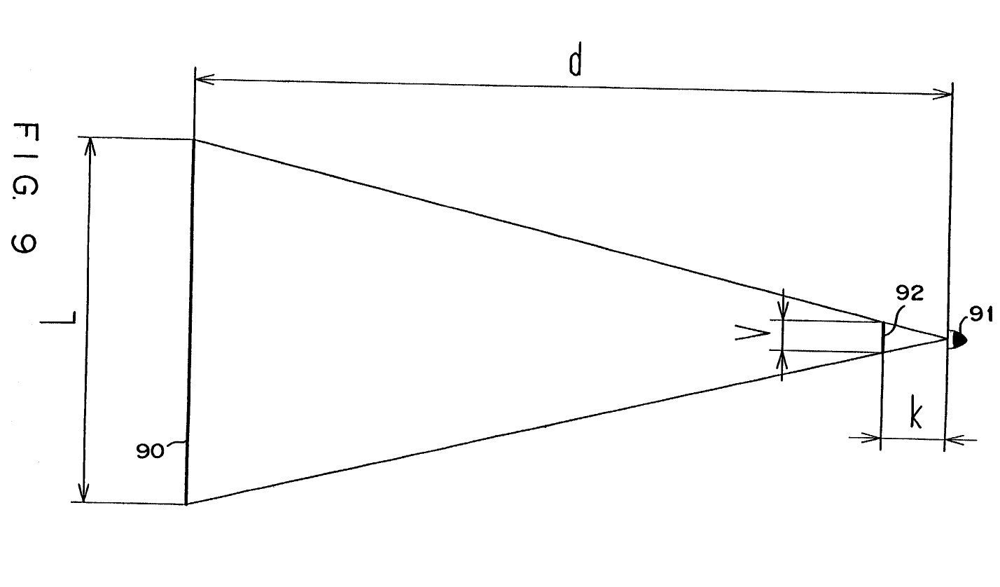

A display image can be an image displayed on the movie screen, but to place a microlens array near a display image in a large-screen movie system, etc., the microlens array is very large, and therefore it is not easy to realize the entire system. A replacing three-dimensional display method of providing a lens having a sufficiently long focal length close to the eyes apart from the display screen is described below by referring to FIG. 9.

FIG. 9 is a sectional view along the plane containing the eyes of an observer of the display system according to the eleventh embodiment of the present invention.

The eyes of an observer 91 are located in the position at the distance d from a two-dimensional display image 90 formed by continuous patterns, and a lens 92 is placed in the position at the distance of k from the eyes. The lens 92 immediately before the eyes of the observer 91, and the distance of k is as small as several tens of centimeters which is sufficiently smaller than the distance of d from the eyes of the observer 91 to the display image 90. Furthermore, the focal length of the lens 92 is longer than the distance of d. Thus, the two-dimensional display image 90 formed by continuous patterns can be viewed as a three-dimensional image. The three-dimensional image effect can be obtained by transferring the position of the entire image of a display image viewed through a lens from the position of the display image.

The closer to the eyes of the observer 91 the lens 92 is placed, the larger display image the observer can see through a smaller lens. The farther the lens 92 is from the eyes of the observer 91, the larger lens the observer requires. In this case, it may be better to use a microlens array having a plurality of small microlenses. When a single lens is used, the entire image can be enlarged or reduced. However, when a microlens array is used, the entire image is formed by combining a number of images of microlenses. Therefore, although an image of each microlens can be enlarged or reduced, the entire image is not enlarged or reduced. On the other hand, the connection between pixels can be worse with the quality of the display degraded.

In any case of a single lens or a microlens array, the image has to be an erect image, and the enlargement rate and the reduction rate cannot be high. The limit depends on the use, and is not predetermined. For example, when each lens in the microlens array is sufficiently small and a plurality of microlenses are arranged, the enlargement rate or the reduction rate does not much affect the quality of an image.

With a single lens and a microlens array having a smaller number of microlenses taken into account, the enlargement or reduction of about 20% or less does not show unnatural appearance. This corresponds to using the lens at the distance of about 1/5 or less of the focal length from the display image to the lens.

For example, when the distance to the lens is set to 1/5 of the focal length, the display image is enlarged by 1.25 times in the case of a convex lens. In the case of a concave lens, the image is 0.833 of the original image.

To obtain a three-dimensional image, the difference in position between the display image and the entire image is important. If an image is apart from a display image by about 20% of the distance between the display image and a lens, then a three-dimensional image can be obtained. This three-dimensional image can be obtained with a shorter distance.

If the focal length of a lens is sufficiently larger than the distance from the lens to the display image, then the distance from the image to the lens is obtained by multiplying the distance from the display image to the lens by the above mentioned enlargement or reduction rate.

Described below is a TV receiver, a poster, etc. in which a display image is relatively close to the display device. In the case of a TV receiver, it is recommended that a user is positioned at the distance of 3 through 7 times the vertical length of the display screen so that the user can view the image with the flickering of the scanning lines sufficiently reduced.

The distance of 7 times the vertical length is recommended in the case of the conventional 4:3 type receiver, and it is recommended for a user to view an image on the display of a small 14-inch type TV at the distance of about 1.5 m or more. Furthermore, there are a number of sizes for posters. Excluding a very special case in which a part of an image is to be viewed in detail, it is normal that a user views an image at the maximum of 1.5 m distant from the image. Using a lens having the focal length of about 8 m which is 5 times the recommended distance, with the above mentioned enlargement or reduction rate of about 20% taken into account, the distance between the display image and the image equals about 20% of the distance from the display image to the lens. This condition is to obtain a three-dimensional image by keeping the distance from the display image of the entire image with the enlargement and reduction of an image and the unnatural appearance reduced for the display image which can be regarded as the lower limit. In this example, a lens having a focal length of 8 m or larger is significant.

When a user views a larger display image at the distance larger than the above mentioned value, a lens having a focal length of 8 m or more can be used. When the distance between the display image and the lens is 1.5 m or shorter, the enlargement or reduction rate is smaller, but an three-dimensional image can be obtained so far as the rate is not too low.

If a lens having a focal length longer than the distance between the display image and the lens is placed at a short distance from the eyes of an observer, the lens can be placed closer to the eyes than the display image with the display image placed inside the focal point. Thus, the image of the display image can be an erect image, and the position of the image is shifted from the position of the display image, thereby being viewed as a three-dimensional image although it is reduced or enlarged.

In the above mentioned explanation, the lens is placed at a short distance from the eyes of the observer. The relative position between the lens and the eyes has a significant meaning.

The lens is placed closer to the eyes than the display image. When the lens is placed at a short distance from the eyes, not very close to the eyes like glasses, a clearer three-dimensional image can be presented. This effect becomes outstanding around the position of 3 cm from the eyes, and more clearly appears with the lens gradually set farther. When a display image is viewed at a long distance like movies, the longer the distance is, the clearer the three-dimensional image appears within reach.

This is confirmed in the range from one meter for a TV receiver to several ten meters in a movie theater. The reason is not clarified, but the phenomenon clearly appears.

Described below is the twelfth embodiment of a lens having a long focal length of the present invention applied to the above mentioned display system. The lens has the structure of a curved plate having the thickness of d and forming a semicylindrical surface. The structure is similar to that of a portion of a cylinder having the inner radius of r and the outer radius of (r+d). That is, the lens has a convex lens surface outside and a concave lens surface inside. By combining the two surfaces, the concave surface having a smaller curvature radius is superior in lens characteristic to the convex surface having a larger curvature radius, thereby presenting the characteristic of a concave lens. The focal length f of the lens is approximately computed by the equation (H) when the thickness d of the lens is small enough than the inner radius r.

f=−r·r/(n−1)*d (H)

where n indicates the refractive index of the lens material. The lens functions as a concave lens, and has a longer focal length inversely proportional to the thickness d and proportional to the square of the inner radius r.

The lens can be easily produced by bending a plate having uniform thickness. Since the total characteristic depends on the difference in lens characteristic between the concave surface and the convex surface, a lens having a long focal length can be easily produced. Furthermore, using a thin flexible plate, the plate can be easily curved, and the focal length can be easily adjusted. Additionally, the focal length can be changed by adjusting the thickness d of the plate.

The lens according to the twelfth embodiment has a semicylindrically curved surface. The curve direction is one-dimensional, and a two-dimensional image viewed through the lens is reduced only in one direction with no reduction or enlargement performed in the direction normal to the above mentioned direction, thereby producing a distorted image. The plate having the thickness d can also be curved spherically. In this case, the curving direction is two-dimensional, and an image can be enlarged and reduced in two directions normal to each other, thereby suppressing unnatural appearance.

It is not always necessary to equally bend the plate in the two direction normal to each other, but it can be appropriately bent in each direction depending on the use condition.

If the semicylindrical lens according to the twelfth embodiment is placed before the eyes of the observer with the central axis of the semicylindrical surface making an angle of 45° with the vertical and horizontal surfaces, and the images in the horizontal and vertical directions appear as having equal magnification, thereby suppressing the deformation of compression or expansion only in a single direction.

A thin flexible plate can be rounded into a cylinder to be a concave lens. In this case, the lens on one inner side and the lens on the other inner side make a combined lend.

When these lenses are placed 3 cm or more from the eyes using a support unit, a clearer three-dimensional image can be realized as described above.

An example of a support unit is an embodiment attached to the head of a user above the neck like the frame of glasses, the helmet of a motorbike driver, etc. Furthermore, a support unit can be a wooden box-shaped frame of glasses. For information, the hood of a helmet is lens, and the other portion is a support unit.

### INDUSTRIAL APPLICABILITY

As described above, the present invention has the following effects.

In the invention according to the 1st aspect, a two-dimensional display image is displayed as a high quality two-dimensional image, and excels in positional reproducibility when the display image is switched.

In the invention according to the 2nd aspect, a two-dimensional display image is displayed as a high quality two-dimensional image, and excels in positional reproducibility when the display image is switched.

Furthermore, if a microlens array is inclined to an observer, the function as a microlens is guaranteed, thereby realizing a clearer three-dimensional image. If a microlens array is inclined to an observer, a clearer three-dimensional image can appear. The distortion of the entire image by the microlens array is almost suppressed.

In the invention according to the 3rd aspect, the re is no boundary surface touching air, thereby having no large reflection on the boundary surface. As a result an observer can easily see a display image, the display image looks bright, and the lighting efficiency can be improved.

In the invention according to the 4th aspect, since the boundary surface functioning as a lens is not air, a microlens array of microlenses having a long focal length, which cannot be easily realized on the boundary touching air, can be easily produced. The control of the focal length can be performed by appropriately selecting the refractive index of the transparent members on both sides of the lens curved surface boundary.

In the invention according to the 5th aspect, a high-contact lens curved surface can be easily produced, and microlenses having various focal lengths can be produced by changing the refractive index of a liquid.

In the invention according to the 6th aspect, a lens having a long focal length can be easily obtained by applying or pressing to a curved member, and a cohesive or adhesive which forms a microlens array by fixing the lens curved surface to a support can also be realized, thereby requiring another cohesive or adhesive.

The invention according to the 7th aspect can reduce the boundary surface touching air having a large reflectivity as compared with the case where a microlens array is separated from a window glass, thereby easily viewing a display image. Furthermore, since a microlens array can be incorporated into a window glass, the shop can appear nice and simple.

Since the invention according to the 8th aspect does not have a boundary surface of a gas functioning as a lens, a microlens array of microlenses having a long focal length, which cannot be easily realized on the boundary touching air, can be easily produced. The control of the focal length can be performed by appropriately selecting the refractive index of the transparent members on both sides of the lens curved surface boundary, thereby selecting an appropriate material from a larger number of selection items.

Furthermore, a pixel is not displayed as a partially enlarged or reduced pixel, the high-quality image can be displayed.

In addition to the effects of the invention according to the 8th aspect, the invention according to the 9th aspect can place a display image in a position closer to the curved surface than a focal point away from the vicinity of the focal point, a high quality image display device can be configured when it is applied to a display device for displaying a two-dimensional display image as being displayed as a three-dimensional image.

The invention according to the 10th aspect can display a high precision two-dimensional display image as a high quality three-dimensional image. Especially, since a microlens can be very small, a smooth and high precision image can be displayed in a three-dimensional array without displaying coarse pixels.

The invention according to the 11th aspect has a curved surface having at least two types of curvature radii, that is, a large radius and a small radius. Based on the difference in production cost of a metal mold, etc., various less expensive metal molds can be used to produce less expensive microlens array having different focal lengths.

The invention according to the 12th aspect can remarkably reduce the moire, thereby largely improving the quality of displayed images.

In the invention according to the 13th aspect, a display image can be placed closer to the lens curved surface than to the focal point, and away from the microlens array if the display device for displaying a three-dimensional image is configured by the microlens array. As a result, a high quality three-dimensional display image can be obtained, and a display image can be easily switched.

Furthermore, with the parallelism of an optical axis of a microlens, the microlens array can be strongly curved.

Furthermore, since the size of the pixels of a display image can be guaranteed by the size of the microlens by the independent optical axis, the quality of a display image can be maintained.

The invention according to the 14th aspect can display a smooth and continuous image without any missing portion of a composite image of microlenses or without double images. As a result, a high quality composite image can be formed.

The invention according to the 15th aspect can suppress the moire when it is applied to an electronic display configured by a regularly arranged display pixels, thereby improving the quality of a display image.

The invention according to the 16th aspect guarantees the function of a lens of microlens in a method of configuring and using a common display device in which a microlens array and a display image are placed as opposed to an observer, thereby improving the characteristic of displaying a three-dimensional image. Since the optical axis of a microlens is independent, an abnormally enlarged or reduced pixel can be suppressed, and the quality of a display image can be improved. Furthermore, during the designing process, the focal length of a microlens can be controlled by changing the position of the optical axis of a microlens.

The invention according to the 17th aspect can locate the entire image of a display image in different positions in the depth direction. Therefore, a clearer three-dimensional image can be displayed. Furthermore, the distortion by the curve of a microlens array can be almost completely suppressed. Furthermore, the entire image is not enlarged or reduced horizontally or vertically, thereby displaying a high quality image. In addition, the independence of the optical axis of a microlens suppresses an abnormally enlarged or reduced pixel, thereby improving the quality of a display image.

The invention according to the 18th aspect can locate the entire image of a two-dimensional display image viewed through the microlens array in different positions in the depth direction. Therefore, a clearer three-dimensional image can be displayed. Furthermore, the entire image is not enlarged or reduced horizontally or vertically, thereby displaying a high quality image. In addition, the independence of the optical axis of a microlens suppresses an abnormally enlarged or reduced pixel, thereby improving the quality of a display image.

Furthermore, a clearer three-dimensional image can be displayed without curving the microlens array, thereby obtaining an effect of reducing the installation space for practical use.

In the invention according to the 19th aspect, the entire image of the two-dimensional display image viewed through the display device can be located in different positions in the depth direction as in the invention according to the 18th aspect. Therefore, a clearer three-dimensional image can be displayed. Furthermore, the entire image is not enlarged or reduced horizontally or vertically, thereby displaying a high quality image. In addition, the independence of the optical axis of a microlens suppresses an abnormally enlarged or reduced pixel, thereby improving the quality of a display image.

Furthermore, a clearer three-dimensional image can be displayed without curving the microlens array, thereby obtaining an effect of reducing the installation space for practical use. A two-dimensional display image can be viewed as a clear three-dimensional image. Furthermore, the image viewed through the device shows little distortion, and the quality of the display image is excellent.

The invention according to the 20th aspect can reduce the reduction or enlargement rate of the entire display image down to 20% approximately. Therefore, since a display image is not extremely reduced or enlarged, a three-dimensional image can be displayed with unnatural appearance successfully suppressed, Additionally, since a support unit keeps the relative position between the lens and the eyes, a display image can be viewed with the movement of the head of an observer.

In the invention according to the 21st aspect, the display image is an erect image, and the position of the image is displaced from the position of the display image. Therefore, the display image can be viewed as a three-dimensional image. Furthermore, since the position of the lens is more than 3 cm apart from the eyes of an observer, a clearer three-dimensional image can appear.

In the invention according to the 22nd aspect, the composite image of a plurality of microlenses is obtained as an entire image, the image is not enlarged or reduced like an image from a single lens. Furthermore, since a support unit is used, the lenses are moved when the head of an observer moves, and a display image can be viewed without unnatural appearance through the lenses.

In the invention according to the 23rd aspect, it is quite easy to produce a lens having a long focal length, and a less expensive lens can be prepared. Additionally, by changing the thickness and curvature, the focal length can be easily changed.

In the invention according to the 24th aspect, each portion of the entire image of the two-dimensional display image viewed through the microlens array can be located in different positions in the depth direction. Therefore, a clearer three-dimensional image can be realized. Furthermore, the entire image can be displayed as an excellent image not enlarged or reduced horizontally and vertically. Additionally, the independence of the optical axis of a microlens removes a large pixel abnormally enlarged or reduced, thereby improving the quality of a display image.

In addition, a clear three-dimensional image can be obtained without curving a microlens array, thereby reducing the installation space when the microlens array is practically used.

In the invention according to the 25th aspect, the entire image of the two-dimensional display image obtained by the display device can locate each portion in a different position in the depth direction as according to the 24th aspect. Therefore, a clearer three-dimensional image can be displayed. In addition, an excellent image can be displayed without enlarging or reducing horizontally or vertically. Furthermore, the independence of a microlens removes a large pixel abnormally enlarged or reduced, and improves the quality of a display image.

Furthermore, a clear three-dimensional image can be obtained without curving a microlens array, thereby reducing the installation space when the microlens array is practically used. A two-dimensional display image can be viewed as a clear and excellent three-dimensional image with little distortion on this display device.

What is claimed is:

1. A display device, comprising:
a microlens array which includes microlenses sufficiently smaller than a length of the side of an effective region and in which optical axes or optical axis surfaces of two adjacent microlenses are independent of each other; and at least one of a two-dimensional display image or an image support for supporting the two-dimensional display image such that the two-dimensional display image can be opposed to the microlens array and disposed at a point close to focal points of the microlenses and at a point not close to curved surfaces of the microlenses in a position between the focal points of the microlenses and the curved surfaces of the microlenses, wherein an observer facing the microlens array can view the two-dimensional display image through the microlenses.

2. The device according to claim 1, wherein
a boundary surface forming the microlens array is evenly and smoothly curved with a radius sufficiently larger than a thickness of the microlens array including a virtual lens surface of the microlens array, and/or the microlens array is inclined to the observer such that a rate of an area in the microlens in which an angle made between eyes of the observer and a normal of a curved surface is larger can increase.

3. The device according to claim 1, wherein
a gap between the curved surface of the lens and the display image is filled with transparent solid, liquid, or clear solid and liquid.

4. A microlens array, comprising:
one or more boundary surfaces on which transparent portions touch each other by layering two or more transparent portions having different refractive indices sufficiently larger than a refractive index of air, wherein at least one of the boundary surfaces forms a lens curved surface including a group of microcurve surfaces arranged at an array pitch sufficiently smaller than a length of one side of an effective region, each of the boundary surfaces, which are lens curved surfaces, has following inequality (1), in which r indicates a curvature radius r of a microcurve surface of the boundary surface which is the lens curved surface, nₚ indicates an absolute refractive index nₚ of one material touching the microcurve surface, nₛ indicates an absolute refractive index nₛ of another material touching the microcurve surface, R indicates a curvature radius of another boundary surface, Nₚ indicates an absolute refractive index Nₚ of one of the materials touching other boundary surfaces, and Nₛ indicates an absolute refractive index Nₛ of the other material touching other boundary surfaces, to the lens curved surface touching the boundary surface which is the lens curved surface and the other boundary surfaces containing the boundary surface to an external region not touching the lens curved surface.

|R/(Nₚ−Nₛ)|>>|r/(nₚ−nₛ)| (1)

5. The array according to claim 4, wherein
at least one of the transparent portions is a transparent liquid, and other transparent portions are transparent solids.

6. The array according to claim 4, wherein
at least one of the transparent portions is a transparent glue or a transparent adhesive, and other transparent portions can be transparent solids.

7. The array according to claim 4, wherein
said lens curved surface is opposed to an outside of a window glass, and a gap between a surface of the outside of the window glass and the lens curved surface is filled with a transparent solid or a transparent liquid.

8. A microlens array, comprising:
one or more boundary surfaces on which transparent portions touch each other by layering two or more transparent portions having different refractive indices sufficiently larger than a refractive index of air, wherein at least one of the boundary surfaces forms a lens curved surface including a group of microcurve surfaces which are arranged at an array pitch sufficiently smaller than a length of one side of an effective region, and two of which are close to each other and have different optical axes or axis surfaces, each of the boundary surfaces, which are the lens curved surfaces, has a following inequality (2), in which r indicates a curvature radius r of the microcurve surface of the boundary surface which is the lens curved surface, nₚ indicates an absolute refractive index nₚ of one material touching the microcurve surface, nₛ indicates an absolute refractive index nₛ of another material touching the microcurve surface, R indicates a curvature radius of another boundary surface, Nₚ indicates an absolute refractive index Nₚ of one of the materials touching other boundary surfaces, and Nₛ indicates an absolute refractive index Nₛ of another material touching other boundary surfaces, to the lens curved surface touching the boundary surface which is the lens curved surface and the other boundary surfaces containing the boundary surface to an external region not touching the lens curved surface.
R/(Nₚ−Nₛ)|>>|r/(nₚ−nₛ)| (2)

9. The array according to claim 8, wherein
a focal point of the microlens formed by a synthetic optical systems having a number of stages of boundary microcurve surfaces forming the lens curved surface is externally disposed apart from the microlens array forming unit, that is, apart more than 5 times the shortest array pitch from the closest microcurve surface.

10. The device according to claim 8, comprising:
said microlens array; and at least one of a two-dimensional image which shows a continuous pattern, is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface, and an image support for supporting a two-dimensional image which is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface.

11. The device according to claim 9, comprising:
said microlens array; and at least one of a two-dimensional image which shows a continuous pattern, is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface, and an image support for supporting a two-dimensional image which is opposed to the lens curved surface of the microlens array, and is disposed between the focal point of the microlens and the lens curved surface of the microlens formed by a synthetic optical system having a number of stages of microcurve surfaces of a boundary surface forming the lens curved surface at the position close to the focal point of the microlens and at the position not close to the lens curved surface.

12. A microlens array, comprising:
a first type of lens curved surface having a group of microcurve surfaces arranged at a sufficiently short pitch than the length of one side of the effective region, and a second type of lens curved surface having a lens curved surface with a sufficiently larger curvature radius than the curvature radius of the microcurve lens surface, wherein
the first type of the lens curved surface is a boundary surface on which a liquid and a solid having different refractive indices or a solid and a solid transparent portion touch each other, and is opposed to the second type of lens curved surface.

13. A microlens array, comprising:
a group of a first microlens having a characteristic of a concave lens and a second microlens having a characteristic of a convex lens arranged at an array pitch sufficiently shorter than a length of one side of an effective region, wherein the first microlens and the second microlens having opposite lens characteristics are connected to each other, and a lens curved surface smoothly continues at a boundary between the first microlens and the second microlens, wherein
said first microlens and/or said second microlens are arranged at random.

14. A microlens array having microlenses sufficiently smaller than the length of one side of the effective region, comprising at least one of:
a region in which focal lengths of the microlenses as well as positions in the microlens array vary; and
a region in which there are a plurality of groups of microlenses having different focal lengths, and the microlenses in each group have substantially equal focal lengths.

15. A display device, comprising:
said microlens array according to claim 14; and
at least one of a two-dimensional display image or an image support for supporting the two-dimensional display image such that the two-dimensional display image can be opposed to the microlens array and disposed at a point close to focal points of the microlenses and at a point not close to curved surfaces of the microlenses in a position between the focal points of the microlenses and the curved surfaces of the microlenses, wherein an observer facing the microlens array can view the two-dimensional display image through the microlenses.

16. A display device, comprising:
a lens; and
a supporting unit for holding the lens such that an effective region of the lens can face eyes of a user, and the eyes of the user can be set approximately 3 cm away from the lens, wherein
said lens can have a focal length sufficiently longer than a distance between the eyes of the user and the lens.

17. The lens according to claim 16, wherein
said lens is a concave lens whose distance between a right and reverse curved surfaces is constant.

18. A microlens array, comprising:
a plurality of microlenses sufficiently smaller than a length of one side of an effective region, wherein
said plurality of microlenses have different focal lengths.

19. A display device, comprising:
said microlens array according to claim 18; and
at least one of a two-dimensional display image or an image support for supporting the two-dimensional display image such that the two-dimensional display image can be opposed to the microlens array and disposed at a point close to focal points of the microlenses and at a point not close to curved surfaces of the microlenses in a position between the focal points of the microlenses and the curved surfaces of the microlenses, wherein an observer facing the microlens array can view the two-dimensional display image through the microlenses.
